(19) United States
(12) Patent Application Publication
(10) Pub. No.: US 2004/0095922 A1
(43) Pub. Date: May 20, 2004

(54) Method and apparatus for interconnecting networks

(76) Inventor: Yasushi Sasagawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/690,094

(22) Filed: Oct. 21, 2003

(30) Foreign Application Priority Data
Oct. 22, 2002 (JP) 2002-306868

(51) Int. Cl. H04L 12/28

(52) U.S. Cl. 370/351

(57) ABSTRACT

A first IP network and a second IP network are provided with a first router device and a second router device which support MPLS. A transport network is provided with one or more core devices supporting GMPLS. A first edge device and a second edge device which support both MPLS and GMPLS are provided at a boundary between the first and second IP networks and the transport network. A GMPLS path is set between the first and second edge devices. An MPLS path is set between the first and second router devices. The MPLS path tunnels the GMPLS path.

### BACKGROUND OF THE INVENTION

1. Field of the Invention

The present invention relates to a method and an apparatus for interconnecting networks, and more specifically to a method and an apparatus for interconnecting an MPLS network and a GMPLS network.

2. Description of the Related Art

Currently, an MPLS working group of the IEFT (Internet Engineering Task Force) is in the process of performing an MPLS (multi-protocol label switching) standardizing operation, and the basic functions have already been determined generally.

The MPLS is a basic technology of realizing the high-speed data transfer, load distribution, and band control for the backbone of the intranet and the Internet. Practically, the MPLS is the technology of combining the routing process in the IP layer (layer 3) with the switching process in the low order layer (layer 2) such as an ATM, frame relay, Ethernet (R), etc., assigns a “label” to an IP packet, and performs forwarding in the layer 2 using the “label” (for example, refer to the Patent document 1).

In the IETF, ITU-T (International Telecommunication Union Telecommunication Standardization Sector), OIF (Optical Internet working Forum), etc., the standardizing operation of the GMPLS (generalized MPLS) which is the technology of applying the above-mentioned MPLS to an optical network/transport network is being performed. In the GMPLS, for example, the information representing a wavelength for transmission of an optical signal is used as a “label” of the MPLS (for example, refer to the Patent document 1).

The GMPLS is a technology obtained by extending the MPLS. That is, as shown in FIG. 1, the MPLS supports a PSC (packet switch capable) interface and an L2SC (layer 2 switch capable) interface. On the other hand, the GMPLS supports a TDM (time division multiplex capable) interface, an LSC (lambda switch capable) interface, an FSC (Fiber Switch capable) interface, etc. in addition to the PSC interface and the L2SC interface.

Thus, the GMPLS supports the PSC interface and the L2SC interface supported by the MPLS. Therefore, if a label is set using the GMPLS, a desired path (LSP: label switched path) can be established without the MPLS as shown in FIG. 2. That is, a transport network and an IP network can be controlled/operated/managed through integration in an IP-based operation only using the GMPLS without the MPLS,

[Patent Document 1]

Japanese Patent Application No. 13-256635 (paragraphs 0002 through 0013, paragraphs 0146 through 0147, FIGS. 18 and 19,)

However, for an IP network, there are already a number of router devices for supporting the MPLS. On the other hand, the MPLS does not have the function (the above-mentioned FSC, LSC, TDM, etc.) of setting a path in the transport network. Therefore, to integrate the transport network with the IP network in which a router device supporting the MPLS in the IP-based operation for control/operation/management, it is necessary to interconnect the MPLS network with the GMPLS network.

When the MPLS network is interconnected with the GMPLS network, a label switched path (LSP) can be set for the PSC interface and the L2SC interface by the signaling of the MPLS, and the label switched path can be set by the signaling of the GMPLS.

However, the signaling protocol of the MPLS is not the same as the signaling protocol of the GMPLS. Practically, the following signaling protocols are available for the MPLS.

LDP: Label Distribution Protocol

RSVP-TE: Extentions to RSVP for LSP Tunnels

CR-LDP: Constraint-Based LSP Setup using LDP

On the other hand, an RSVP-TE-extended protocol, and a CR-LDP-extended protocol are available for the GMPLS, but the LDP is not available. Therefore, when the LDP is used as a signaling protocol for the MPLS, the MPLS network cannot be interconnected to the GMPLS network. It is considered that various complicated processes are required to interconnect them.

Therefore, as shown in FIG. 3, it is difficult to interconnect the IP networks supporting the MPLS through a transport network supporting the GMPLS.

In addition, as shown in FIG. 4, although the data plane for transmission of data is not separate from the control plane for transmission of control information in the MPLS, the planes are completely separate from each other in the GMPLS. This also makes it difficult to interconnect the MPLS network to the GMPLS network.

### SUMMARY OF THE INVENTION

The present invention aims at providing a method and an apparatus for interconnecting networks which support different protocols, and especially a method and an apparatus for easily interconnecting an MPLS network to a GMPLS network.

The network connecting method according to the present invention is a method of interconnecting the first MPLS network to the second MPLS network which support the signaling protocol of the MPLS through the GMPLS network which supports the signaling protocol of the GMPLS. A first path is set using a signaling protocol of the GMPLS between a first edge node provided at the boundary between the GMPLS network and the first MPLS network and a second edge node provided at the boundary between the GMPLS network and the second MPLS network. A second path which tunnels the first path is set using the signaling protocol of the MPLS between the first MPLS network and the second MPLS network.

In this method, since the second path interconnecting the MPLS networks is set such that the second path can tunnel the first path established in the GMPLS network, it is not necessary for the device configuring the MPLS network and the device configuring the GMPLS network to transmit and receive a signaling message. Therefore, the MPLS network can be easily connected to the GMPLS network.

Another connecting method according to the present invention is a method of interconnecting the first MPLS network to the second MPLS network through the GMPLS network. A first path is set using the signaling protocol of the GMPLS between a first edge node provided at the boundary between the GMPLS network and the first MPLS network and a core device provided in the GMPLS network. A second path is set using the signaling protocol of the GMPLS between a second edge node provided at the boundary between the GMPLS network and the second MPLS network and the core device. A third path for tunneling the first path and the second path is set between the first edge node and the second edge node using the signaling protocol of the GMPLS. A fourth path for tunneling the third path is set between the first MPLS network and the second MPLS network using the signaling protocol of the MPLS.

In this method, the third path tunnels the first path and the second path. That is, the third path connects the first edge device to the core device, and also connects the core device to the second edge device. Therefore, the MPLS network can be connected to the GMPLS network, and the core device can terminate a signal transmitted through the third path. That is, the core device can provide a service of a layer corresponding to the third path. Especially, if the third path and the fourth path belong to the same layer, the core device can provide the same service as the service provided over the MPLS network.

A further connecting method according to the present invention is a method of interconnecting the first MPLS network to the second MPLS network through the GMPLS network. A first path is set using the signaling protocol of the GMPLS between a first edge node provided at the boundary between the GMPLS network and the first MPLS network and a core device provided in the GMPLS network. A second path is set using the signaling protocol of the GMPLS between a second edge node provided at the boundary between the GMPLS network and the second MPLS network and the core device. A third path for tunneling the first path and the second path is set between the first MPLS network and the second MPLS network using the signaling protocol of the MPLS.

In this method, the third path connects the first MPLS network to the core device, and also connects the core device to the second MPLS network. Therefore, the MPLS network can be connected to the GMPLS network, and a predetermined core device in the GMPLS network can provide a service of the layer corresponding to the third path in simpler procedure and configuration than any other methods of the above-mentioned aspects.

### BRIEF DESCRIPTION OF THE DRAWINGS

FIG. 1 is an explanatory view of the extension from the MPLS to the GMPLS;

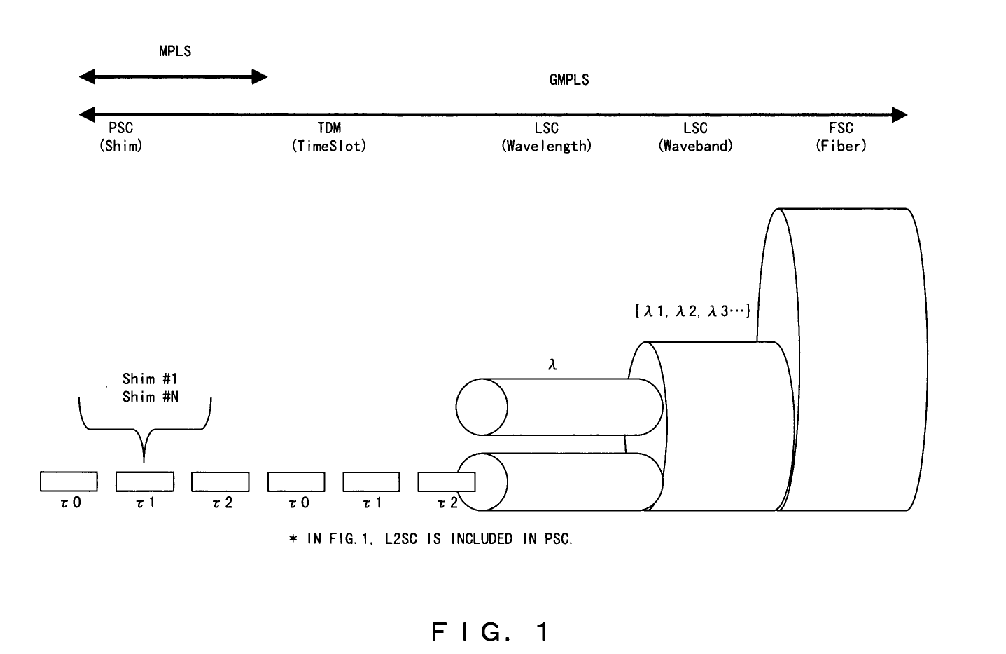

FIG. 2 shows a path set by the GMPLS;

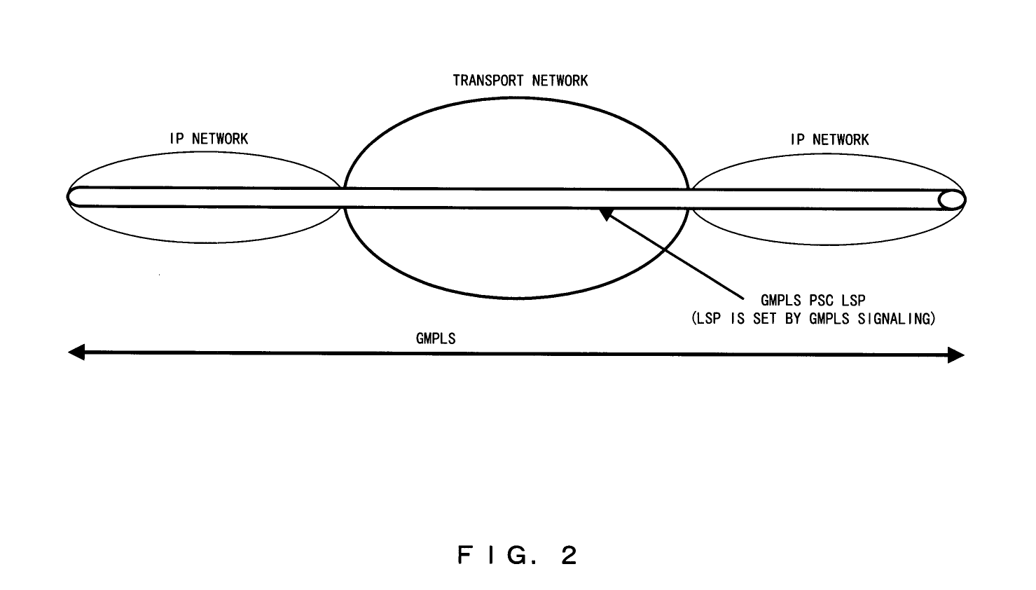

FIG. 3 is an explanatory view of the problem when an MPLS network is connected to a GMPLS network in the conventional technology;

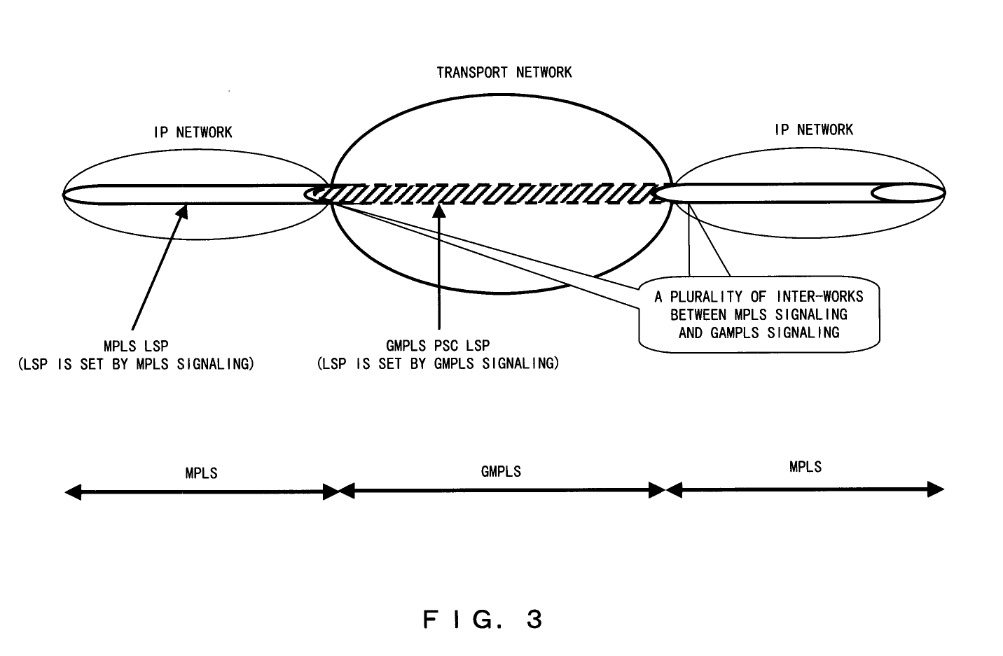

FIG. 4 shows a control plane of the MPLS and the GMPLS;

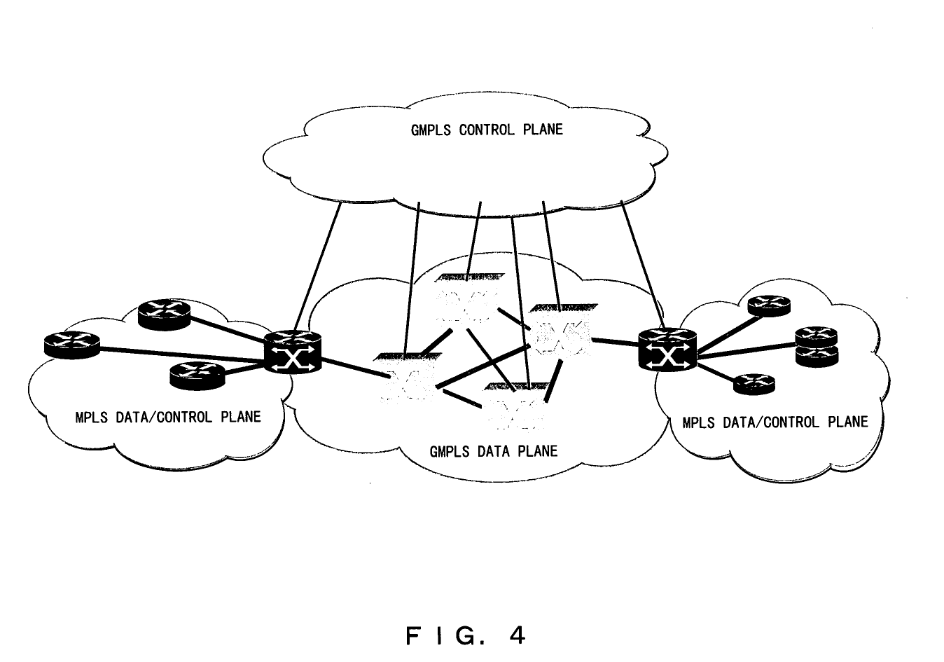

FIG. 5 shows the configuration of a network according to the present invention;

FIG. 6 shows the outline of the connection between the networks according to the first embodiment of the present invention;

FIG. 7 shows the sequence of signaling according to the first embodiment of the present invention;

FIG. 8 shows an example of a table provided in an input side edge device according to the first embodiment of the present invention;

FIG. 9 shows an example of a table provided in an output side edge device according to the first embodiment of the present invention;

FIG. 10 shows an example of a table provided in the core device;

FIG. 11 shows an embodiment of an operation of transferring a packet using a path established in a method according to the first embodiment of the present invention;

FIG. 12 shows the format of a packet transmitted over a transport network according to the first embodiment of the present invention;

FIG. 13 shows the outline of the connection between the networks according to the second embodiment of the present invention;

FIG. 14 shows the sequence of signaling according to the second embodiment of the present invention;

FIG. 15 shows an example of a table provided in an input side edge device according to the second embodiment of the present invention;

FIG. 16 shows an example of a table provided in an output side edge device according to the second embodiment of the present invention;

FIG. 17 shows the format of a packet transmitted over a transport network according to the second embodiment of the present invention;

FIG. 18 shows an example of a table provided in a core device for performing a process of a packet layer;

FIG. 19 shows an embodiment of an operation of transferring a packet using a path established in a method according to the second embodiment of the present invention;

FIG. 20 shows the outline of the connection between the networks according to the third embodiment of the present invention;

FIG. 21 shows the sequence of signaling according to the third embodiment of the present invention;

FIG. 22 shows an embodiment of an operation of transferring a packet using a path established in a method according to the third embodiment of the present invention;

FIG. 23 shows an embodiment of a method of interconnecting networks according to the present invention;

FIG. 24 shows the configuration of the apparatus which supports both MPLS and GMPLS;

FIG. 25 shows the configuration of a circuit module;

FIG. 26 shows the configuration of a control module; and

FIG. 27 is a schematic diagram showing the configuration and operations of an edge device.

### DESCRIPTION OF THE PREFERRED EMBODIMENTS

The embodiments of the present invention are described below by referring to the attached drawings.

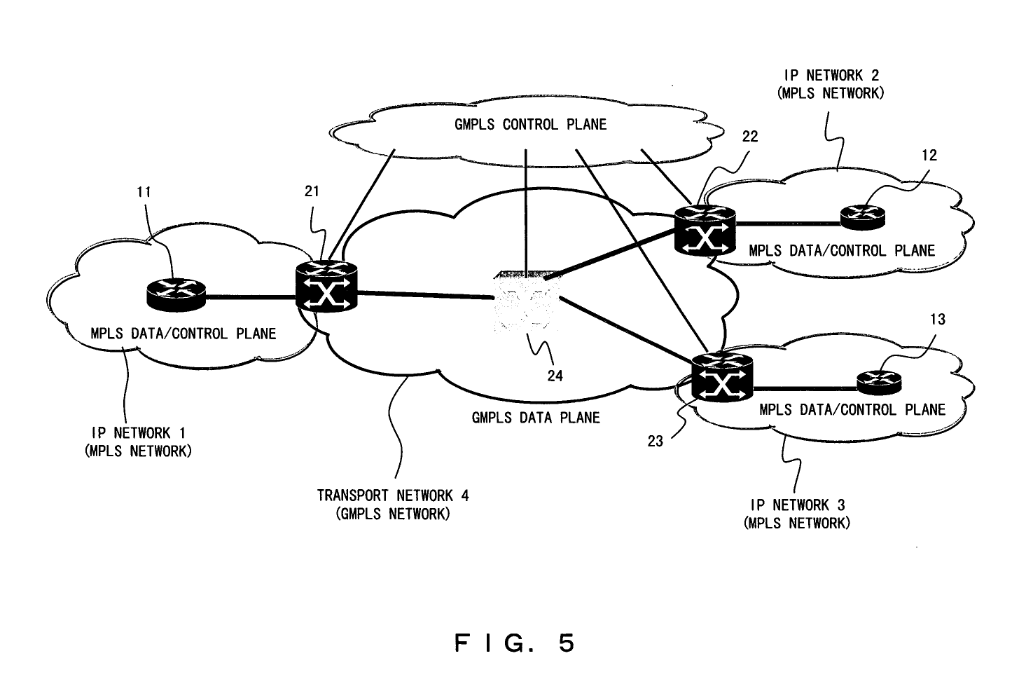

FIG. 5 shows the configuration of the network to which the present invention is applied. In FIG. 5, IP networks 1 through 3 are interconnected through a transport network 4.

The IP networks 1 through 3 are provided with a plurality of router devices, and transfer an IP packet. In this embodiment, arbitrary router devices provided for the IP networks 1 through 3 are referred to as router devices 11 through 13, respectively.

The router devices provided for the IP networks 1 through 3 support the MPLS. That is, the IP networks 1 through 3 are MPLS networks. The MPLS is the label switching technology (or label transfer technology) prescribed by the RFC 3031. “Supporting the MPLS” refers to supporting at least the signaling protocol of the MPLS. In the MPLS network, a data plane for transmission of data is not separate from a control plane for transmission of control information.

The transport network 4 is a network for providing a communications service of a transport layer, or a network for providing a communications service of a layer lower than an IP layer or a packet layer, and is provided with a plurality of communications nodes. In this embodiment, the communications nodes provided at the boundary between the transport network 4 and the IP networks 1, 2, and 3 are referred to as edge devices (or edge nodes) 21, 22, and 23, respectively. The communications nodes other than the edge devices in the transport network 4 are referred to as core devices (or core nodes). In FIG. 5, one of a plurality of core devices is shown as a core device 24.

The edge devices 21 through 23 support both MPLS and GMPLS. Additionally, the core device 24 supports the GMPLS. That is, the transport network 4 is a GMPLS network. The GMPLS is the technology of the MPLS extended to a transport layer. “Supporting the GMPLS” refers to supporting at least a signaling protocol of the GMPLS. In the GMPLS network, a data plane for transmission of data is separate from a control plane for transmission of control information.

First Embodiment

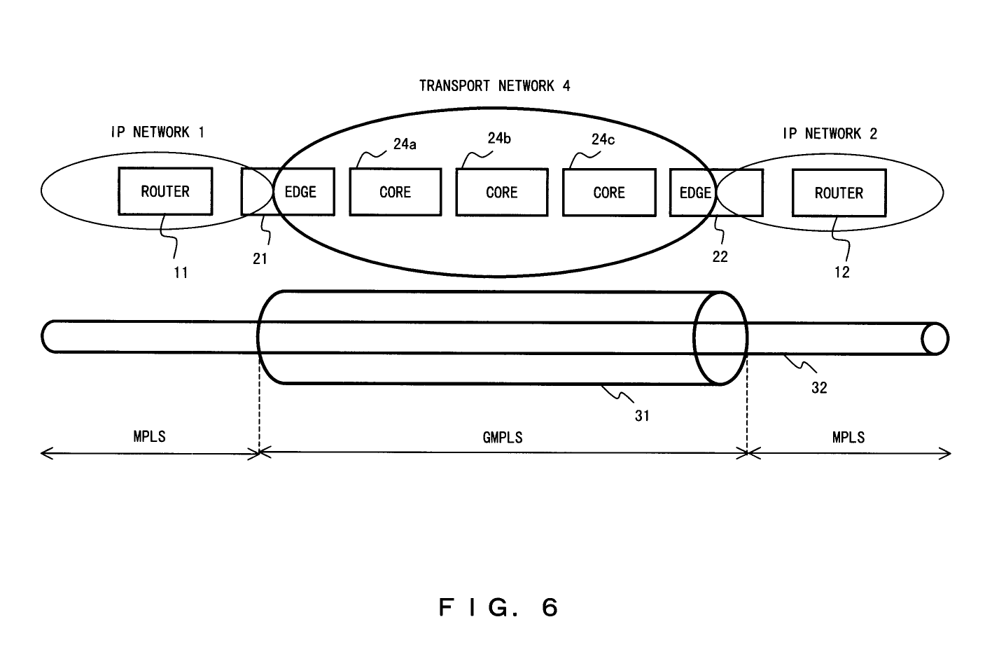

FIG. 6 shows the outline of the connection between the networks according to the first embodiment of the present invention. The router device 11 and the router device 12 are IP routers for supporting the MPLS as described above. The edge device 21 is an edge device provided at the boundary between the IP network 1 and the transport network 4. The edge device 22 is an edge device provided at the boundary between the IP network 2 and the transport network 4. The edge device 21 and the edge device 22 support both MPLS and GMPLS. Furthermore, the core devices 24a through 24c are communications nodes corresponding to the core device 24 shown in FIG. 5, and support the GMPLS.

In the above-mentioned network system, a path 31 via the core devices 24a through 24c is set by the signaling of the GMPLS between the edge device 21 and the edge device 22. The path 31 is, for example, a k path (wavelength path) set by the LSC (lambda switch capable) of the GMPLS. The “λ path” is a label switched path in which the optical wavelength for transmitting a signal is used as a “label”.

The path 31 is not limited to a λ path, but can be a path of any type set by the signaling of the GMPLS. That is, the path 31 can be a path in which an identification information to identify optical fiber for transmitting a signal is used as a label (realized by the FSC (Fiber Switch Capable) of the GMPLS). Additionally, the path 31 can be a path in which a time slot for transmitting a signal is used as a label in a time division-multiplex transmission (realized by the TDM (Time Division Multiplex capable) of the GMPLS). Furthermore, the path 31 can be a path identified by a label set by the PSC (Packet Switch Capable) or the L2SC (layer 2 switch capable) of the GMPLS.

Between the router device 11 and the router device 12, a path 32 is set in the path 31 by the signaling of the MPLS. The path 32 is, for example, a label switched path of the packet layer of the MPLS.

Thus, in the connecting method according to the first embodiment, the first path is set between edge nodes on the GMPLS network, and the second path for connection of the MPLS networks is set in the first path. Therefore, the IP networks not supporting the signaling protocol of the GMPLS can be interconnected through the GMPLS network.

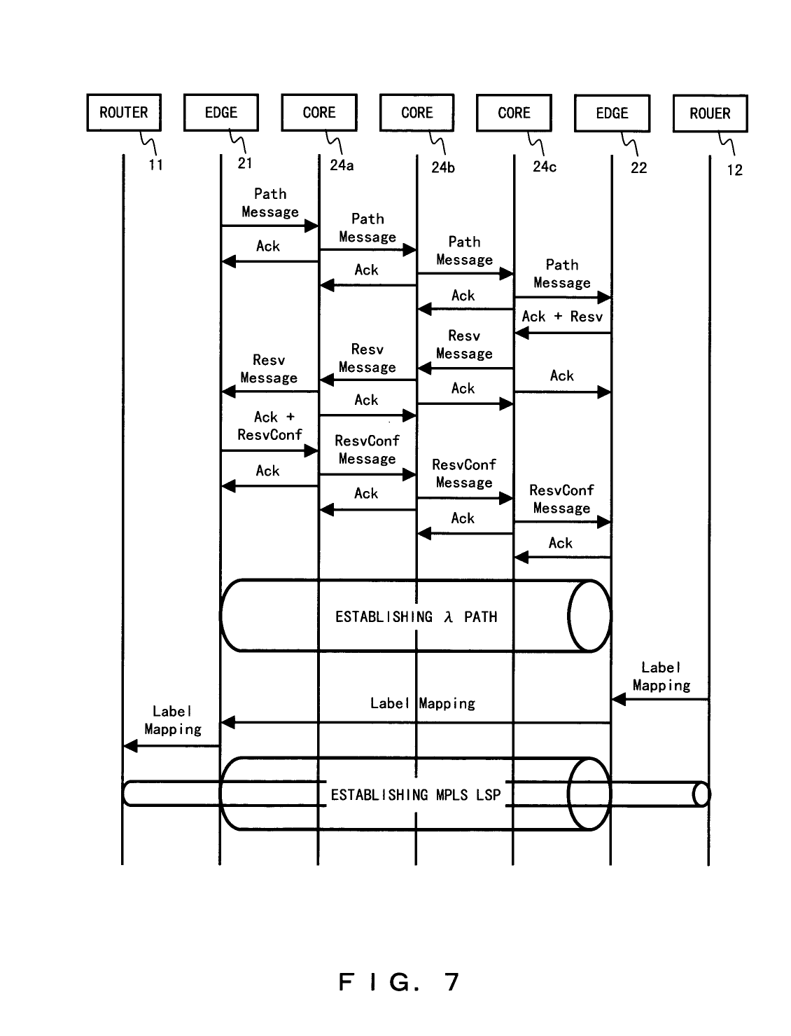

FIG. 7 shows the sequence of the signaling according to the first embodiment of the present invention. Described below is the sequence of setting a path shown in FIG. 6. The protocol used when the λ path is set between the edge devices 21 and 22 is assumed to be the RSVP-TE (resource reservation protocol with traffic engineering extensions) of the GMPLS. The protocol used when a label switched path is set between the router devices 11 and 12 is in the Downstream Unsolicited Ordered Control mode of the label distribution protocol (LDP) of the MPLS.

First, a path message for a request to set a λ path is transmitted from the edge device 21 to the edge device 22. This path message is transferred to the edge device 22 through the core devices 24a through 24c. Upon receipt of that path message, the edge device 22 determines the wavelength for transmitting a signal between the core device 24c and the edge device 22, and transmits a reservation message (Resv) for notification of the wavelength to the core device 24c. Similarly, the core device 24c, the core device 24b, and the core device 24a generates the respective reservation messages for notification of a corresponding wavelength, and transmits them to the core device 24b, the core device 24a, and the edge device 21, respectively. In the GMPLS, a set of bi-directional paths can be set for bi-directional transmission of a signal. In this case, the edge device 21, the core device 24a, the core device 24b, and the core device 24c respectively transmit to the core device 24a, the core device 24b, the core device 24c, and edge device 22 a path message (path-conf) including an object for notification of a corresponding wavelength to a path in the direction from the edge device 22 to the edge device 21. The reservation confirmation message transmitted by the edge device 21, the core devices 24a, 24b, and 24c is specifically used for confirmation of the setting of the path in the direction from the edge device 22 to the edge device 21. In the GMPLS, the edge devices 21 and 22, and the core devices 24a through 24c basically return an acknowledgment message (Ack) corresponding to a received message.

In the above-mentioned sequence, upon receipt of the reservation message or the reservation confirmation message, the edge devices 21 and 22, and the core devices 24a through 24c update various tables referred to when a packet or a signal is transferred according to the message. Thus, a λ path is established between the edge device 21 and the edge device 22. These tables are described later.

Then, a label mapping message for a request to set a label switched path is transmitted by the signaling of the MPLS from the router device 12 to the router device 11. The label mapping message is a message for notification of the information about the label to be assigned to the packet. In this case, the label mapping message from the router device 12 is transmitted to the router device 11 through the edge device 22 and the edge device 21. At this time, the message is not terminated by the core devices 24a through 24c.

In this sequence, according to the label mapping message, router devices 11, 12 and the edge devices 21, 22 update various tables referred to when a packet is transferred. Thus, the label switched path by the MPLS for connecting the router device 11 to the router device 12 is established in the λ path by the above-mentioned GMPLS. That is, since the λ path of the GMPLS and the label switched path of the MPLS are hierarchically generated by the LSP tunneling, the RSVP-TE signaling protocol of the GMPLS for setting a λ path can be operated independent of the label distribution protocol of the MPLS for setting a label switched path. As a result, it is not necessary to perform a complicated process to connect the MPLS network to the GMPLS network.

As described above, according to the first embodiment, no signaling messages are communicated between a device supporting only the MPLS (router devices 11 and 12 in the present embodiment) and a device supporting only the GMPLS (core devices 24a through 24c in the present embodiment). Therefore, although the interconnection between the signaling protocol of the MPLS and the signaling protocol of the GMPLS is not guaranteed, the MPLS network can be connected to the GMPLS network.

The trigger of setting a λ path is not specifically restricted. However, for example, it is checked according to the topology information whether or not the edge device 21 can set a λ path from the edge device 21 to the edge device 22. If it is determined that the λ path can be set, then the sequence shown in FIG. 7 can be started. Although the trigger of setting a label switched path of the MPLS is not specifically restricted, the sequence shown in FIG. 7 can be started when, for example, an Egress label advertisement policy is set in the router device 12.

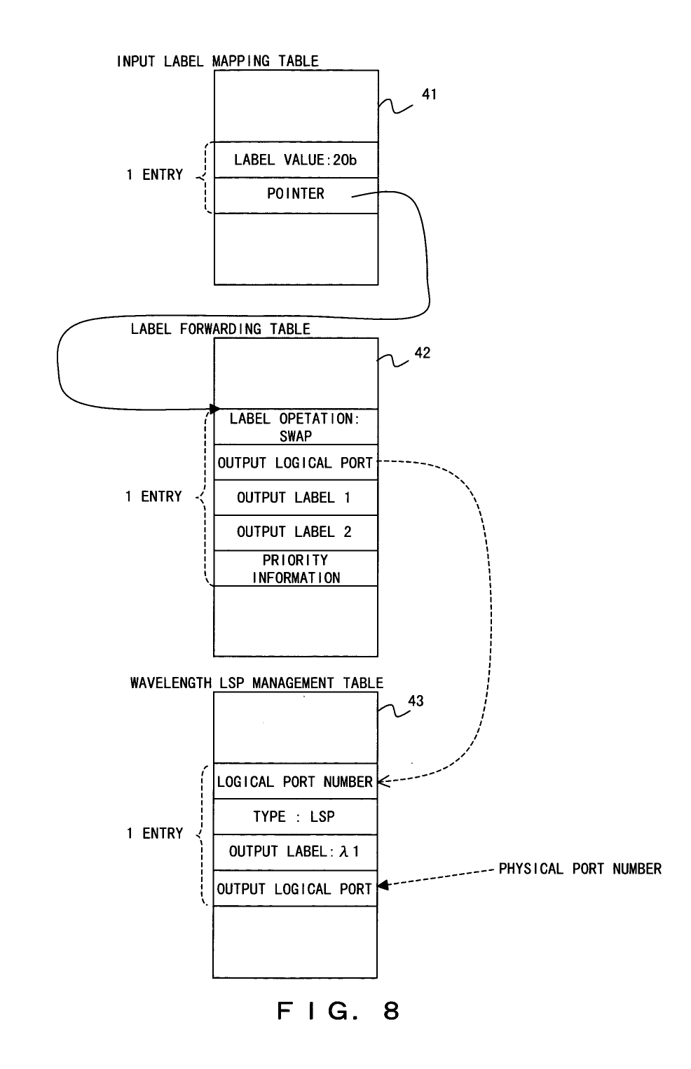

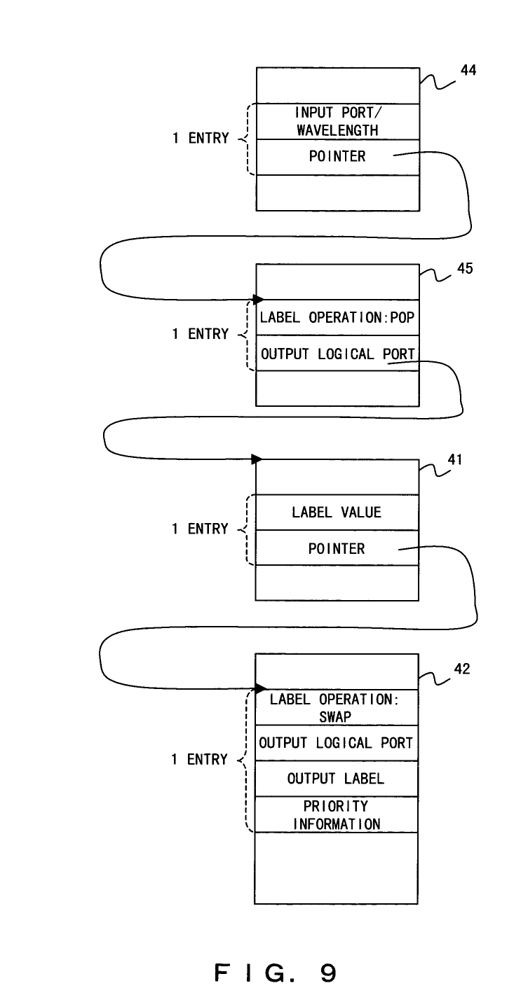

FIGS. 8 and 9 show examples of tables provided for the edge device provided at the boundary between the IP network and the transport network. These tables are referred to when a packet or a signal is transferred.

FIG. 8 is a table referred to when a packet incoming from the IP network to the transport network is processed. In FIG. 8, an input label mapping table 41 manages a “label value” and a “pointer” for each entry. The “label value” is distributed by, for example, a label distribution protocol of the MPLS. The “pointer” points to an address area storing the information corresponding to a “label value”.

A label forwarding table 42 manages a “label operation”, an “output logical port”, an “output label”, and a “priority information” for each entry. A “label operation” identifies a swap (operation of rewriting an input label into an output label), a push (operation of adding a label), a pop (operation of deleting a label). In this embodiment, it is assumed that a “swap” is set. The “output logical port” identifies a logical port from which a received packet is output. The “output label” is a label value to be assigned to an output packet, and is distributed by the label distribution protocol of the MPLS. As a “priority information”, for example, a QoS value predetermined by, for example, negotiation, etc. is written.

The wavelength LSP management table 43 manages a “logical port number”, a “type”, an “output label”, and an “output logical port” for each entry. The “logical port number” is an identification number indicated by the “output logical port” of the label forwarding table 42. The “type” identifies the type (FSC, LSC, TDM, L2SC, PSC, etc.) of path set by the GMPLS. In the present embodiment, since a λ path is set between the edge devices 21 and 22, the “LSC (Lambda Switch Capable)” is set. The “output label” is a label value to be assigned to an output packet. However, in the present embodiment, a λ path is set. Therefore, a “wavelength for transmitting a signal” is set as a “label”. The information (wavelength information or a wavelength label) about the wavelength is announced by a reservation message (Resv) or a path message (Path-Conf) of the GMPLS in the embodiment shown in FIG. 7. The “output logical port” identifies a port from which a signal is output.

When the edge device provided with the above-mentioned table receives a packet from an IP network, it retrieves a pointer from the input label mapping table 41 using a label (input label) assigned to the packet as a key, and accesses the label forwarding table 42 according to the pointer. Then, the edge device rewrites the label (input label) assigned to the received packet into an output label recorded in the label forwarding table 42. According to the output logical port recorded in the label forwarding table 42, the edge device accesses a wavelength LSP management table 43. Furthermore, the edge device transmits the label-rewritten packet through the output port recorded in the wavelength LSP management table 43 using the wavelength recorded in the wavelength LSP management table 43.

FIG. 9 is a table referred to when a packet outgoing from the transport network to the IP network is processed. In FIG. 9, an input wavelength label mapping table 44 manages an “input port/wavelength label” and a “pointer” for each entry. A value distributed according to a reservation message (Resv) of the GMPLS or a path message (Path-Conf) is written as the “input port/wavelength label”. The “pointer” points to an address area storing the information corresponding to the “input port/wavelength label”.

A wavelength label forwarding table 45 manages a “label operation” and an “output logical port”. The “label operation” is the information for use in processing a wavelength for transmitting a signal, and a “pop” is recorded in the edge device which processes a packet outgoing from the transport network to the IP network. A pointer for use in checking an input label assigned to a received packet is written as the “output logical port”. Like the edge device for processing a packet incoming from the IP network to the transport network, the edge device for processing a packet outgoing from the transport network to the IP network is also provided with the input label mapping table 41 and the label forwarding table 42 for rewriting a label set in a Shim header.

Upon receipt of a signal from an adjacent node (for example, from a core node), the edge device provided with the above-mentioned tables retrieves a pointer using as a key a combination of the input port of the signal and the wavelength of the signal, and accesses the wavelength label forwarding table 45 according to the pointer. At this time, since a “label operation=pop”, the edge device recognizes that the device terminated the λ path. Then, the edge device retrieves a packet from the received signal, rewrites the label of the packet into the output label recorded in the label forwarding table 42, and outputs it through a corresponding output port.

Thus, in the edge device according to the first embodiment, a label for a label switched path distributed in the signaling procedure of the MPLS and wavelength information for a λ path announced in the signaling procedure of the GMPLS are associated with each other and recorded. Thus, label stacking is realized between the MPLS and the GMPLS.

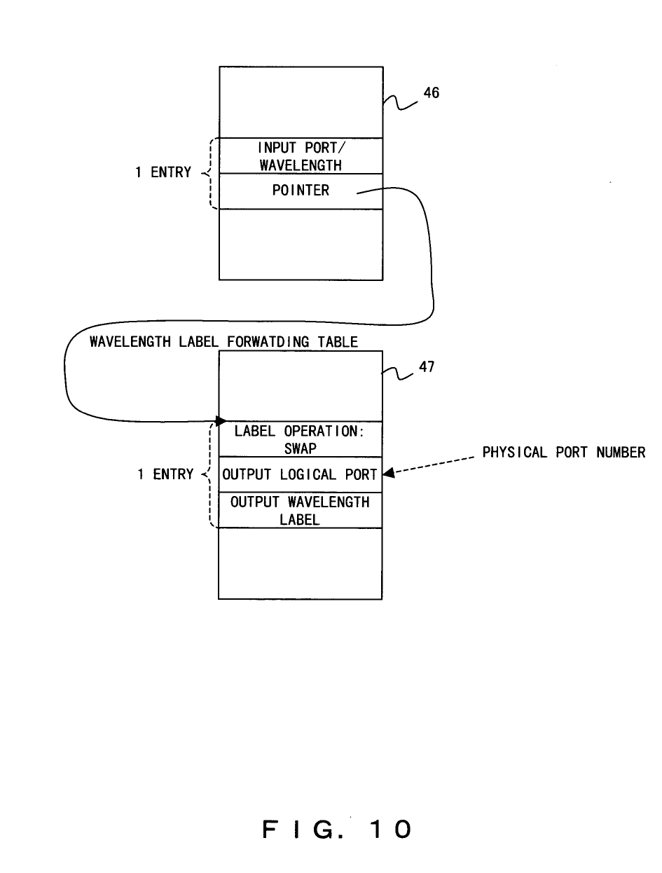

FIG. 10 shows an example of tables provided for the core devices 24a through 24c prepared in the transport network. These tables are referred to when a received signal is transferred to the next node.

Like the input wavelength label mapping table 44 described above by referring to FIG. 9, an input wavelength label mapping table 46 stores a pointer for access to a wavelength label forwarding table 47 based on the input port/input wavelength.

The wavelength label forwarding table 47 stores a “label operation”, an “output logical port”, and an “output wavelength label” for each entry. The “swap” is set for the “label operation” in the core device. The “output logical port” identifies a port from which a signal is output. The “output wavelength label” indicates a wavelength to be used when a signal is transmitted. The wavelength is announced according to, for example, a reservation message (Resv) or a path message (Path-Conf) of the GMPLS.

Upon receipt of a signal from an adjacent node, the core device provided with the above-mentioned tables transfers the signal to the next node using the wavelength recorded in the wavelength label forwarding table 47 through the output port recorded in the wavelength label forwarding table 47.

Since the routing table and the MPLS forwarding table provided in each router device in the IP network are the same as those generated in the conventional technology, the detailed explanation is omitted here.

The label processing (including the process of rewriting a label in the Shim header, and the process of converting a wavelength through which a signal is transmitted) performed by the edge device and/or the core device can be either realized by software processing, hardware processing, or a combination of software and hardware.

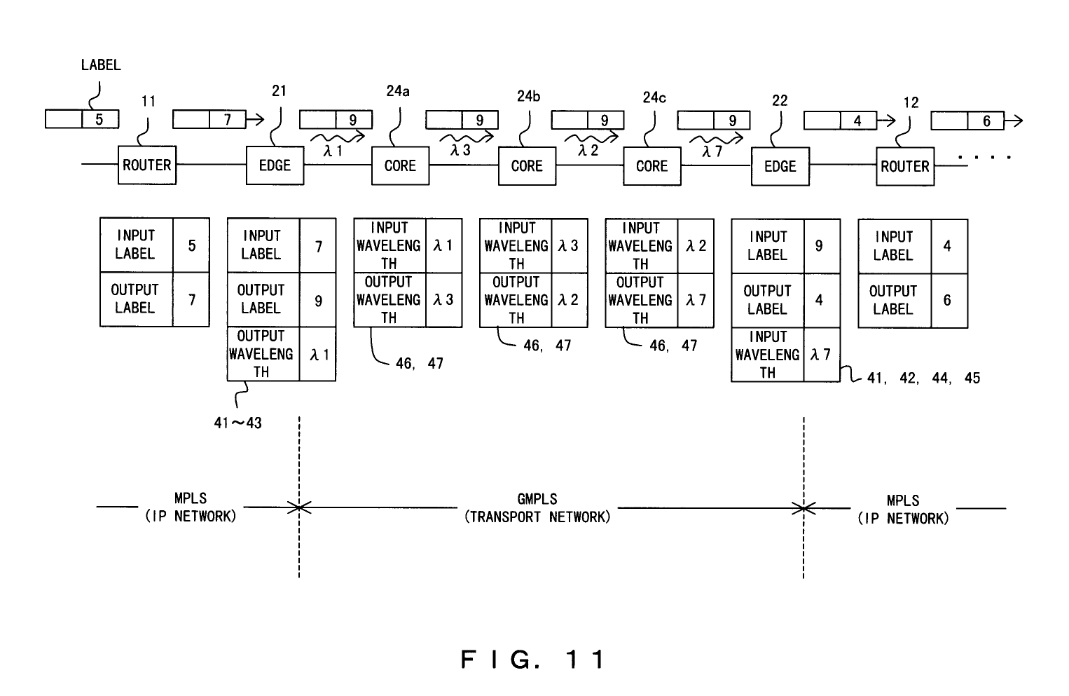

FIG. 11 shows an embodiment of the operation of transferring a packet using a path established in the method according to the first embodiment. In this embodiment, it is assumed that the MPLS forwarding table provided for the router devices 11 and 12, the tables 41 through 43 provided for the edge device 21, the tables 41 through 43 provided for the edge device 21, the tables 41, 42, 44, and 45 provided for the edge device 22, and the tables 46 and 47 provided for the core devices 24a through 24c have been set by the signaling shown in FIG. 7. It is also assumed that a port number is not considered.

A packet transmitted in the transport network is assigned a Shim header before the IP header. In the Shim header, a TTL (time to live) indicating the duration of an IP packet, an S bit indicating whether or not it is the bottom of a label stack, a label value for realization of a label switched path, etc. are set.

In this network, when a packet assigned the “label=7” is received from the router device 11, the edge device 21 refers to the table shown in FIG. 8, rewrites the label value from “7” to “9”, and transmits the packet to the core device 24a using the wavelength λ1. The “output label=9” is recorded in the label forwarding table 42. The “output wavelength=λ1” is recorded in the wavelength LSP management table 43.

Upon receipt of the signal with the wavelength λ1, the core device 24a refers to the table shown in FIG. 10, converts the wavelength of the signal from “λ1” to “λ3”, and transmits it to the core device 24b. At this time, the label in the Shim header assigned to the packet cannot be rewritten (the packet itself cannot be recognized). The core device 24b converts the wavelength of the signal from “λ3” to “λ2”, and the core device 24c converts the wavelength of the signal from “λ2” to “λ7”. In this case, the core devices 24b and 24c cannot rewrite the label in the Shim header assigned to the packet (the packet itself cannot be recognized.) That is, in the transport network, the wavelength for transmitting a signal in each node (core device) is converted, but the label in the Shim header assigned to the packet is not be rewritten. Thus, when a packet with the “label=9” incomes from the IP network to the transport network, the packet is encapsulated by the “wavelength” and transmitted in the λ path. That is to say, the packet is transferred from an IP network to another IP network by tunneling a GMPLS network.

Upon receipt of a signal of the wavelength of λ7 from the core device 24c, the edge device 22 refers to the table shown in FIG. 9, and detects that the label operation is “pop”. In this case, the edge device 22 detects the label set in the Shim header from the received signal, replaces the label “9” with “4”, and transmits the signal to the router device 12. The “output label=9” is recorded in the label forwarding table 42 shown in FIG. 9. The subsequent processes are the same as those in the conventional MPLS network.

Thus, when MPLS networks are interconnected through a GMPLS network according to the first embodiment, a label switched path is generated by the MPLS such that the label switched path tunnels the GMPLS network. A packet generated in the MPLS network is transmitted through the label switched path of the MPLS. Therefore, using a newly generated GMPLS network, the existing MPLS networks can be easily connected to each other.

In the network of the first embodiment, one or more GMPLS paths can be set outside or parallel to the path 31. In this case, the GMPLS paths can be terminated by an arbitrary node through which the path 32 passes. Furthermore, another MPLS path can be set inside or parallel to the path 31.

Second Embodiment

In the first embodiment explained by referring to FIGS. 6 through 11, a path (the λ path in the embodiment) of the GMPLS is set in the transport network, and a path (the label switched path of the MPLS in the embodiment) of a packet layer is set in the λ path. Thus, in the first embodiment, a service of a packet layer cannot be provided in the transport network. On the other hand, according to the second embodiment, in the configuration in which IP networks (MPLS networks) are interconnected through a transport network (GMPLS network), a service (for example, QoS, etc.) of a packet layer can be provided in the transport network.

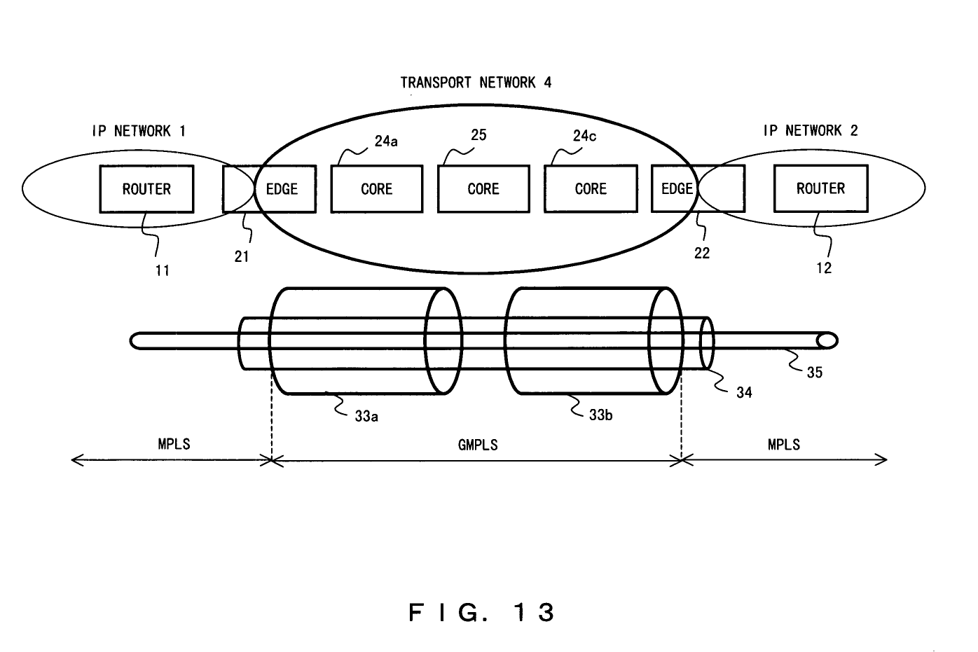

FIG. 13 shows the outline of the connection between the networks according to the second embodiment of the present invention. In FIG. 13, the router devices 11 and 12, the edge devices 21 and 22, and the core devices 24a and 24c are the same as those according to the first embodiment. That is, the router devices 11 and 12 are IP routers supporting the MPLS. The edge devices 21 and 22 support both MPLS and GMPLS. Furthermore, the core devices 24a and 24c support the GMPLS. On the other hand, like the core devices 24a and 24c, a core device 25 supports the GMPLS. However, the core device 25 is a node having the function of providing a service (QoS, etc.) of a packet layer.

In this network system, a path 33a is set between the edge device 21 and the core device 25 by the signaling of the GMPLS. Similarly, a path 33b is set between the edge device 22 and the core device 25 by the signaling of the GMPLS. The path 33a and the path 33b are, for example, λ paths set by the LSC (lambda switch capable) of the GMPLS.

The paths 33a and 33b are not limited to λ paths, but can be any type of paths set by the signaling of the GMPLS. That is, the paths 33a and 33b can be paths in which an identification information to identify an optical fiber for transmitting a signal is used as a label, or paths in which a time slot for transmitting a signal is used as a label in the time division-multiplex transmission.

Furthermore, a path 34 of a packet layer through the core device 25 is generated between the edge device 21 and the edge device 22 through the path 33a by the signaling of the GMPLS. The path 34 is a label switched path of the packet layer of the GMPLS. In this case, the path 34 is set by the PSC (packet switch capable) of the GMPLS.

Additionally, a path 35 is set in the path 34 by the signaling of the MPLS between the router device 11 and the router device 12. Like the path 32 according to the first embodiment, the path 35 is a label switched path of the packet layer of the MPLS.

When the path is established as described above, for example, a packet incoming from the IP network 1 to the transport network 4 is transferred to the core device 25 by tunneling the core device 24a through the path 33a. The core device 25 can terminate the packet and perform the process (for example, QoS, etc.) of a packet layer. The packet tunnels the core device 24c through the path 33b, and is transferred to the edge device 22, and output from the edge device 22 to the IP network 2. Thus, according to the connecting method of the second embodiment, a service of the packet layer can be provided in the transport network.

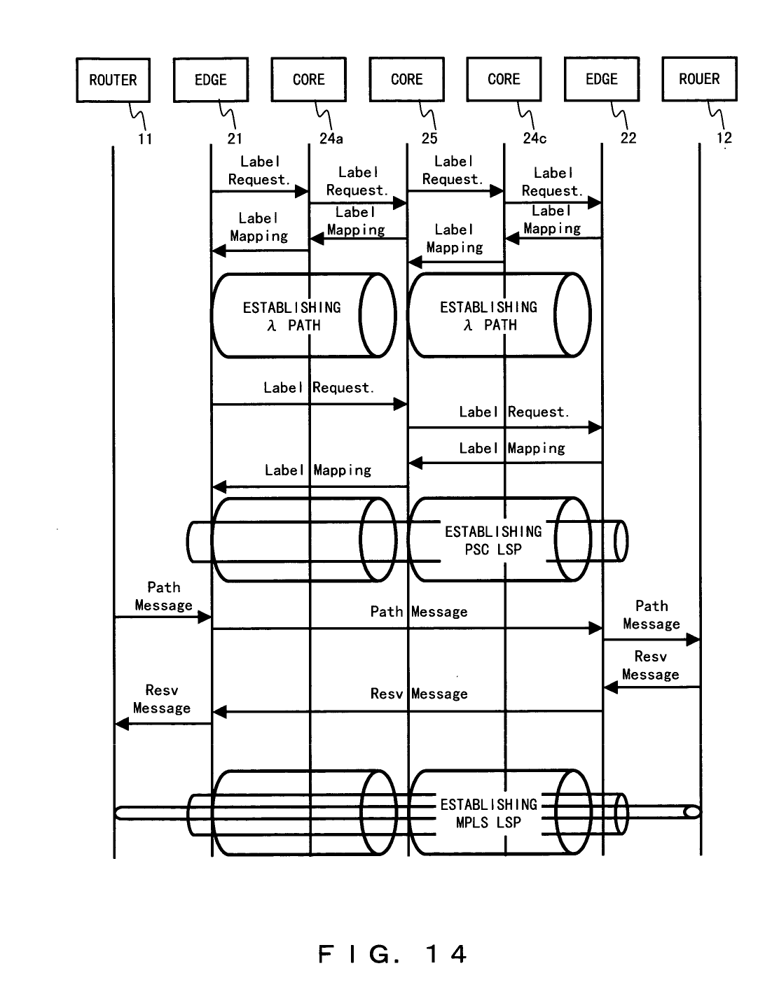

FIG. 14 shows the sequence of the signaling according to the second embodiment. Described below is the sequence of setting a path shown in FIG. 13. It is assumed that a protocol used when each λ path is set between the edge device 21 and the core device 25 and between the edge device 22 and the core device 25 is the CR-LDP signaling of the GMPLS. The protocol used when a label switched path is set between the edge devices 21 and 22 is also assumed to be the CR-LDP signaling of the GMPLS. Furthermore, the protocol used when a label switched path is set between the router devices 11 and 12 is assumed to be the RSVP-TE signaling of the MPLS.

A label request message for a request to set a λ path is transmitted from the edge device 21 to the core device 25. At this time, the message is transferred to the core device 25 through the core device 24a. Upon receipt of the label request message, the core device 25 determines the wavelength for transmitting a signal, and notifies the core device 24a of the wavelength using a label mapping message. The core device 24a notifies the edge device 21 of the corresponding wavelength using the label mapping message.

Similarly, a label request message for a request to set a λ path is transmitted from the core device 25 to the edge device 22. At this time, the message is transferred to the edge device 22 through the core device 24c. Upon receipt of the label request message, the edge device 22 determines the wavelength for transmitting a signal, and notifies the core device 24c of the wavelength using a label mapping message. Furthermore, the core device 24c notifies the core device 25 of the corresponding wavelength using the label mapping message.

In this sequence, the edge devices 21 and 22, the core devices 24a, 24c, and 25 update various tables referred to when a packet or a signal is transferred according to the above-mentioned label mapping message. Thus, a λ path of the GMPLS is established between the edge device 21 and the core device 25, and between the core device 25 and the edge device 22.

Then, a label request message for a request to establish a label switched path is transmitted from the edge device 21 to the edge device 22. In this case, the label request message transmitted from the edge device 21 is transmitted to the edge device 22 via the core device 25. Then, upon receipt of the label request message, the edge device 22 determines a label specifying a label switched path, and notifies the core device 25 of the label using the label mapping message. Similarly, the core device 25 notifies the edge device 21 of the corresponding label using the label mapping message. At this time, these messages are not terminated by the core devices 24a and 24c.

In this sequence, the edge devices 21 and 22, and the core device 25 update various tables referred to when a packet is transferred. Thus, a label switched path is established by the GMPLS via the core device 25 between the edge device 21 and the edge device 22. This label switched path is established in the above-mentioned λ path.

Furthermore, a path message for a request to establish a label switched path is transmitted from the router device 11 to the router device 12. At this time, the message is transmitted to the router device 12 via the edge device 21 and the edge device 22. Then, upon receipt of the path message, the router device 12 determines the label for designating a label switched path, and notifies the edge device 22 of the label using the reservation message (Resv). The edge device 22 similarly notifies the edge device 21 of the corresponding label using the reservation message. Furthermore, the edge device 21 similarly notifies the router device 11 of the corresponding label using the reservation message. At this time, the message is not terminated by the core devices 24a, 24c, and 25.

In this sequence, the router devices 11 and 12, and the edge devices 21 and 22 update various tables referred to when a packet is transferred according to the reservation message. Thus, a label switched path by the MPLS is established between the router device 11 and the router device 12. The label switched path is set in the above-mentioned label switched path established by the GMPLS. That is, by the LSP tunneling, the label switched path of the packet layer of the GMPLS and the label switched path of the MPLS are hierarchically generated. Therefore, the CR-LDP signaling protocol of the GMPLS and the RSVP-TE signaling protocol of the MPLS can be independently operated. As a result, it is not necessary to perform a complicated process for connecting the MPLS network with the GMPLS network.

Since the core device 25 operates as a relay device for a label switched path of a packet layer, the core device 25 can provide a service of the packet layer.

The trigger of setting a λ path is not specifically restricted. However, for example, if the edge device 21 checks by referring to the topology information whether or not a λ path from the edge device 21 to the core device 25 can be set, it can be determined that such λ path can be set, and the core device 25 checks by referring to topology information whether or not a λ path from the core device 25 to the edge device 22 can be set, and it is determined that the λ path can be set, then the sequence shown in FIG. 14 can be started. Although the trigger of setting a label switched path by the GMPLS is not specifically restricted, for example, the sequence shown in FIG. 14 can be started after the setting of the above-mentioned λ path is flooded by each device, the edge device 21 checks by referring to topology information whether or not a label switched path of a packet layer from the edge device 21 to the edge device 22 can be set, and can determine that the path can be set. Furthermore, although the trigger of setting a label switched path of the MPLS is not specifically restricted, for example, the sequence shown in FIG. 14 can be started when the established policy of the ER-LSP terminated by the router device 12 through the edge devices 21 and 22 is set by the router device 11.

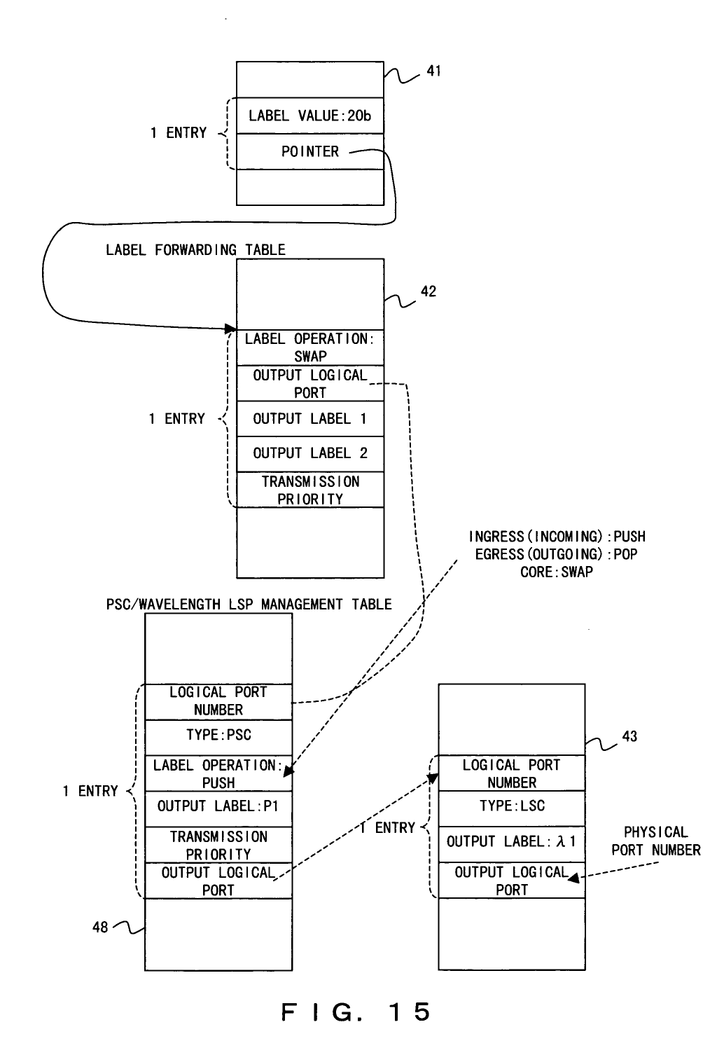

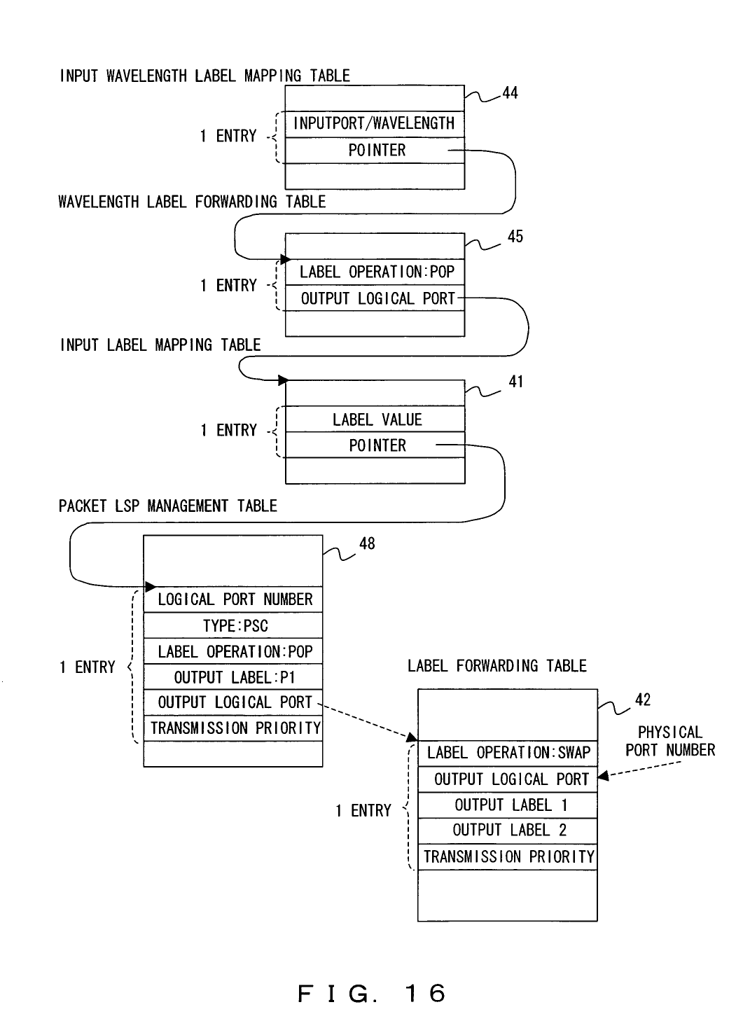

FIGS. 15 and 16 show examples of the tables provided for the edge device according to the second embodiment. FIG. 15 is a table referred to when a packet incoming from an IP network to a transport network is processed. FIG. 16 is a table referred to when a packet outgoing from a transport network to an IP network is processed.

The configuration of the tables provided for the edge device according to the second embodiment are basically the same as the configuration of the tables explained by referring to FIGS. 8 and 9 according to the first embodiment. However, the input side edge device according to the second embodiment comprises a packet LSP management table 48 in addition to the input label mapping table 41, the label forwarding table 42, the wavelength LSP management table 43.

The packet LSP management table 48 manages a “logical port number”, a “type”, a “label operation”, an “output label”, and an “output logical port”. The “logical port number” is an identification number indicated by the output logical port of the label forwarding table 42. The “type” refers to the type of a path (FSC, LSC, TDM, L2SC, PSC, etc.) set by the GMPLS. In the embodiment, since a label switched path of the packet layer by the GMPLS is set between the edge devices 21 and 22, a “PSC” is set. A “push” is set for the “label operation” of the input side edge device. A “pop” is set for the output side edge device. The “output label” is a label value to be assigned to an output packet. This label is announced according to a label mapping message of the GMPLS in the embodiment shown in FIG. 14. The “output logical port” indicates a port through which a packet is output.

In the input side edge device according to the second embodiment, a link is set between the output logical port of the label forwarding table 42 and the logical port number of the packet LSP management table 48, and a link is set between the output logical port of the packet LSP management table 48 and the logical port number of the wavelength LSP management table 43. Therefore, the label for the label switched path distributed in the signaling procedure of the MPLS, the label for the label switched path distributed in the signaling procedure of the GMPLS, and the wavelength information for the λ path notified in the signaling procedure of the GMPLS are associated with each other and recorded.

Upon receipt of a packet incoming from an IP network to a transport network, the edge device provided with the above-mentioned tables refers to the label forwarding table 42 and rewrites the label of the packet. The edge device assigns the output label recorded in the packet LSP management table 48 to the packet. The edge device outputs the packet by the wavelength recorded in the wavelength LSP management table 43.

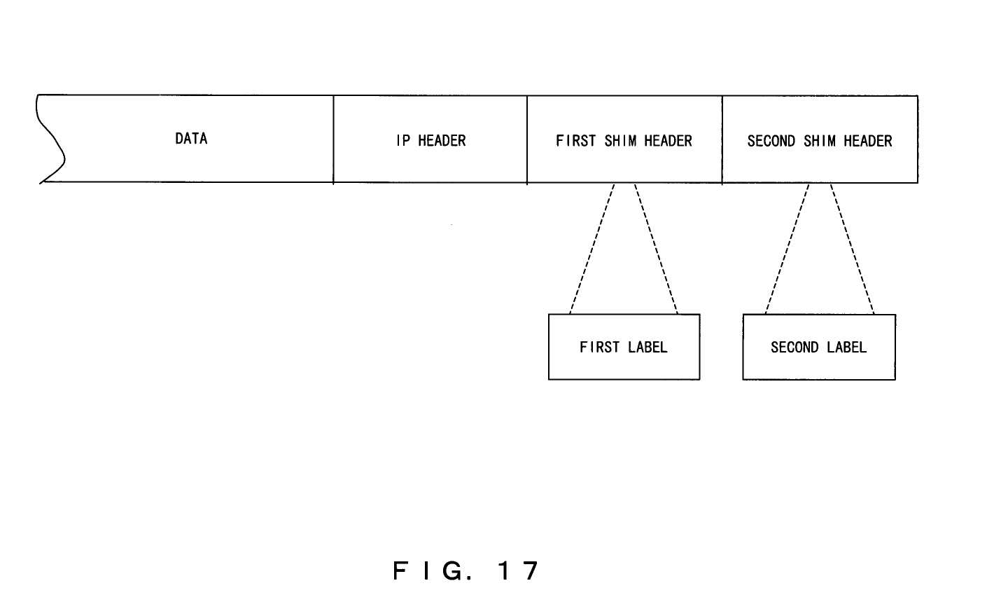

FIG. 17 shows the format of the packet transmitted in the transport network according to the second embodiment. The packet is assigned a first Shim header and a second Shim header. In this embodiment, the first Shim header stores a first label, and the second Shim header stores a second label. The second Shim header is assigned by the edge device when a packet enters a transport network from an IP network.

On the other hand, the edge device for processing a packet outgoing from a transport network to an IP network is provided with the input wavelength label mapping table 44, the wavelength label forwarding table 45, the input label mapping table 41, the packet LSP management table 48, and the label forwarding table 42 as shown in FIG. 16. Here, a “label operation=pop” is set in the packet LSP management table 48, and a “label operation=swap” is set in the label forwarding table 42.

Upon receipt of a signal from a transport network, the output side edge device provided with the above-mentioned tables regenerates a packet from the signal, refers to the packet LSP management table 48, and deletes the label of the second Shim header. The edge device rewrites the first Shim header in the packet according to the label forwarding table 42, and outputs the packet to the IP network.

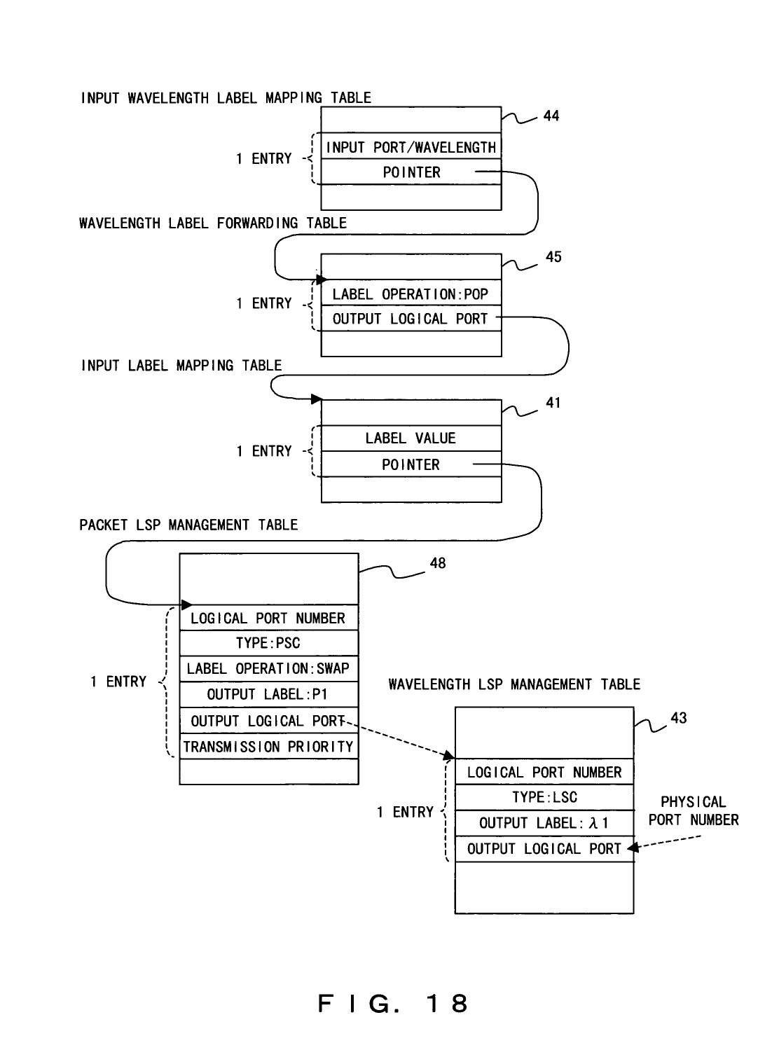

FIG. 18 shows an example of tables provided for the core device 25. The configuration of the tables of the core device 25 is basically the same as the configuration of the tables of the output side edge device explained above by referring to FIG. 16. However, a “label operation=swap” is set in the packet LSP management table 48 provided for the core device 25. The core device 25 is also provided with the wavelength LSP management table 43 instead of the label forwarding table 42 provided for the output side edge device. The “output label” for designation of an output wavelength is recorded in the wavelength LSP management table 43.

The core device 25 provided with the above-mentioned tables accesses the packet LSP management table 48 based on the input port and the input wavelength of the received signal, and regenerates a packet from the received signal. Then, the core device 25 refers to the packet LSP management table 48, rewrites the label of the second Shim header of the packet, and performs the QoS process according to the priority information. Then, the core device 25 transmits the packet with the output wavelength set in the wavelength LSP management table 43.

The tables provided for the core devices 24a and 24c are described above by referring to FIG. 10. The operations of the core devices 24a and 24c are the same as those according to the first embodiment.

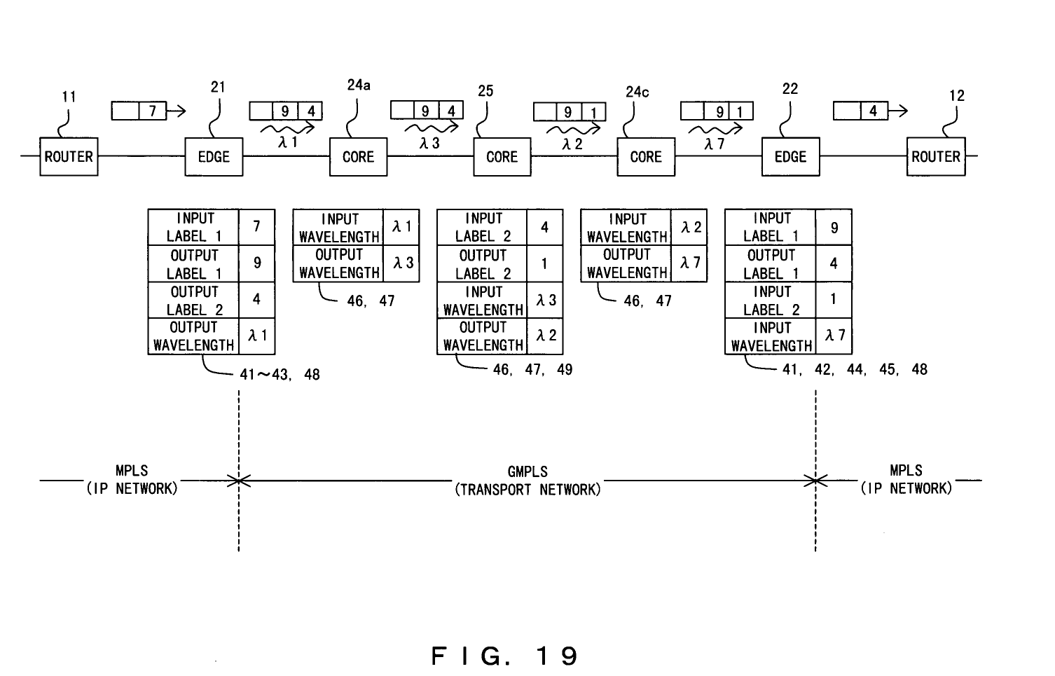

FIG. 19 shows an embodiment of the operation of transferring a packet using a path established in the method according to the second embodiment. In this embodiment, it is assumed that the tables 41 through 43 and 48 provided for the edge device 21, the tables 41, 42, 44, 45, and 48 provided for the edge device 22, the tables 46 and 47 provided for the core devices 24a and 24c, and the tables 46, 47, and 49 provided for the core device 25 have already been set by the signaling shown in FIG. 14.

In this network, upon receipt of the packet assigned the “first label=7” from the router device 11, the edge device 21 refers to the tables shown in FIG. 15, rewrites the label value from “7” to “9”, and assigns the “second label=4” to the packet. Then, the edge device 21 transmits the packet to the core device 24a with the wavelength λ1. The “output label=9” is recorded in the label forwarding table 42. The “second label=4” is recorded in the packet LSP management table 48. The “output wavelength=λ1” is recorded in the wavelength LSP management table 43.

Upon receipt of the signal with the wavelength λ1, the core device 24a converts the wavelength of the signal from “λ1” to “λ3”, and transmits it to the core device 24b as in the first embodiment. At this time, no labels assigned to the packet is rewritten.

The core device 25 regenerates a packet from the received signal, and rewrites the second label of the packet from “4” to “1”. At this time, the core device 25 provides a service of a packet layer (QoS, etc.) according to a label forwarding table 49 shown in FIG. 18. Then, the core device 25 transmits the packet to the core device 24c with the wavelength λ2.

Upon receipt of a signal with the wavelength λ2 from the core device 25, the core device 24c converts the wavelength of the signal from “λ2” to “λ7”, and transmits it to the edge device 22 as in the first embodiment. At this time, no labels assigned to the packet is rewritten.

Thus, according to the embodiment, a packet is transferred without rewriting the first label. That is, a packet incoming from one IP network is transferred to another IP network by tunneling a transport network. However, a label switched path of a packet layer is establish between the edge device 21 and the core device 25, and between the edge device 22 and the core device 25. The packet is terminated by the core device 25, and the core device 25 can provide a service of the packet layer for the packet.

Upon receipt of a signal with the wavelength λ7 from the core device 24c, the edge device 22 regenerates a packet from the received signal, deletes the second label from the packet, rewrites the first label of the packet from “9” to “4”, and then transmits the packet to the router device 12.

Thus, according to the second embodiment, a path which tunnels a GMPLS network can be set, and a service of the packet layer can be provided in a desired node in the GMPLS network.

In the network of the second embodiment, one or more GMPLS paths can be set outside or parallel to the path 33a and path 33b. In this case, the GMPLS paths can be terminated by an arbitrary node through which the path 33a or path 33b passes. In addition to that, one or more GMPLS paths (PSC LPS) can be set outside or parallel to the path 34. In this case, the GMPLS paths can be terminated by an arbitrary node through which the path 34 passes. Furthermore, another GMPLS path (PSC LPS) can be set inside or parallel to the path 35.

Third Embodiment

According to the second embodiment described above by referring to FIGS. 13 to 19, a service of the packet layer can be provided by the core device 25 in the transport network. However, in this embodiment, the configuration of a path is somewhat complicated as shown in FIG. 13. On the other hand, according to the third embodiment, the configuration of a path can be simplified in a system that a service (for example, QoS, etc.) of the packet layer is provided in the transport network.

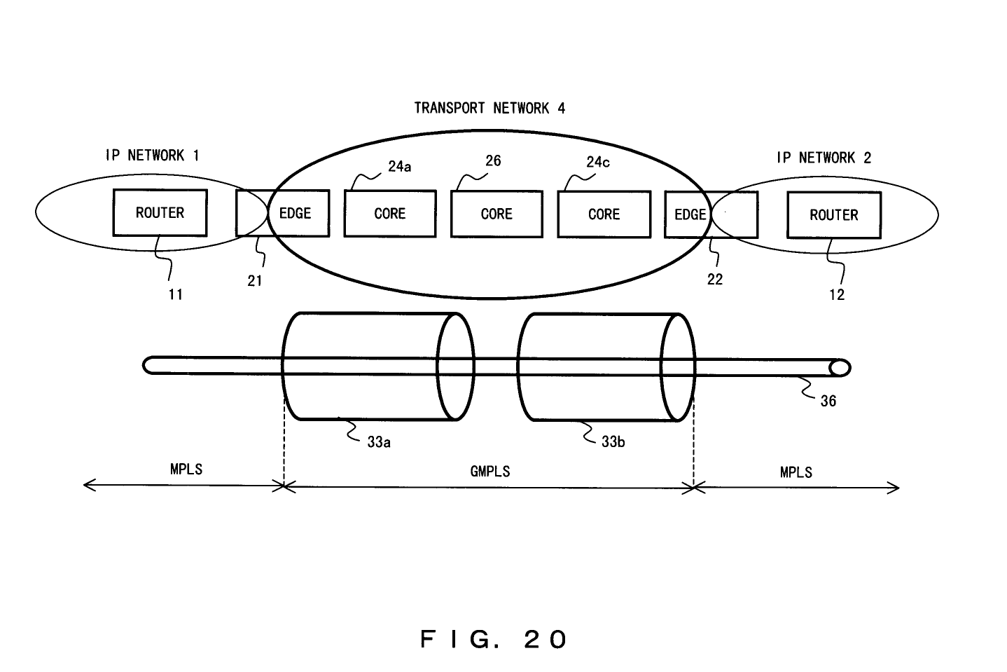

FIG. 20 shows the outline of the connection between networks according to the third embodiment of the present invention. The router devices 11 and 12, the edge devices 21 and 22, and the core devices 24a and 24c are the same as the corresponding devices according to the first and second embodiment. That is, the router devices 11 and 12 are the IP router which support the MPLS. The edge devices 21 and 22 support both MPLS and GMPLS. The core devices 24a and 24c support the GMPLS. On the other hand, a core device 26 supports both MPLS and GMPLS like the edge devices 21 and 22. The core device 26 is also a node having the function of providing a service (QoS, etc.) of a packet layer.

In this network system, the path 33a is established between the edge device 21 and the core device 26 by the signaling of the GMPLS. Similarly, the path 33b is established between the edge device 22 and the core device 26 by the signaling of the GMPLS. The paths 33a and 33b are described above in the second embodiment.

A path 36 is set between the router device 11 and the router device 12 by the signaling of the MPLS. The path 36 is established in the paths 33a and 33b. The path 36 is a label switched path of a packet layer of the MPLS like the path 32 according to the first embodiment or the path 35 according to the second embodiment.

When a path is established as described above, for example, a packet incoming from the IP network 1 to the transport network 4 is transferred to the core device 26 by tunneling the core device 24a through the path 33a. The core device 26 can terminate the packet, and perform a process (for example, QoS, etc.) of a packet layer. The packet is transferred by tunneling the core device 24c through the path 33b, and output from the edge device 22 to the IP network 2. Thus, according to the connecting method of the third embodiment, a service of a packet layer can be provided in the transport network as in the connecting method according to the second embodiment. However, the configuration of a path is simpler in the third embodiment than in the second embodiment.

As described above, in the third embodiment, a path (for example, a λ path) is set by the signaling of GMPLS between nodes which necessarily refer to the information about a packet layer in the transport network, and a packet is communicated between the nodes through the path. Therefore, the these nodes are virtually connected through a packet interface.

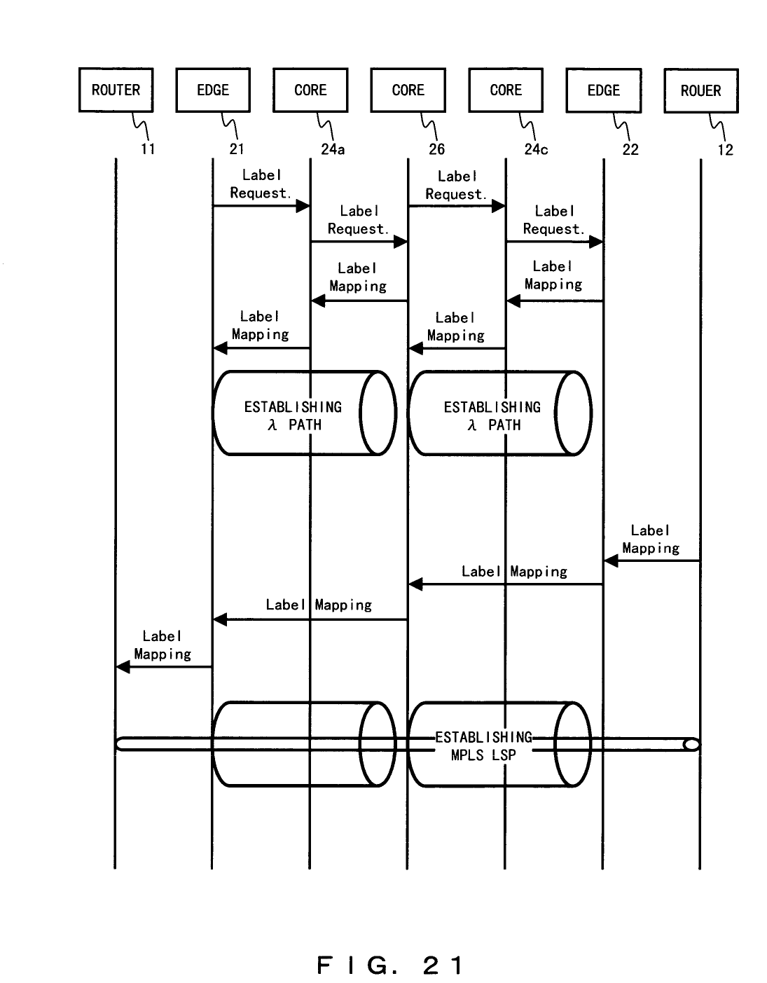

FIG. 21 shows the sequence of the signaling according to the third embodiment. The sequence of setting a path shown in FIG. 20 is described below. A protocol used when a λ path is set between the edge device 21 and the core device 26, and between the edge device 22 and the core device 26 is assumed to be CR-LDP signaling of the GMPLS. A protocol used when a label switched path is set between the router devices 11 and 12 is assumed to be in a downstream unsolicited ordered control mode of the label distribution protocol of the MPLS.

The procedure of setting a λ path between the edge device 21 and the core device 26, and the procedure of setting a λ path between the core device 26 and the edge device 22 are the same as those explained above by referring to FIG. 14. Therefore, the explanation is omitted here.

A label mapping message by the MPLS is transmitted from the router device 12 to the router device 11 for notification of the label of the label switched path. The message is transmitted to the router device 12 through the edge device 22, the core device 26, and the edge device 21. The core device 26 supports not only the GMPLS, but also the MPLS, and, like the edge devices 21 and 22, performs a corresponding process according to a label mapping message of the MPLS.

In this sequence, the router devices 11 and 12, the edge devices 21 and 22, and the core device 26 update various tables referred to when a packet is transferred. Thus, a label switched path is established between the router devices 11 and 12 through the edge device 21, the core device 26, and the edge device 22. The label switched path is established in the above-mentioned λ path. That is, since a label switched path of a packet layer of the GMPLS and a label switched path of the MPLS are hierarchically generated by the LSP tunneling, the CR-LDP signaling protocol of the GMPLS and the label distribution protocol of the MPLS can be independently operated. Therefore, no complicated process is required to connect the MPLS network to the GMPLS network.

Additionally, since the core device 26 functions as a relay device of a label switched path of a packet layer, a service of a packet layer can be provided in the core device 26.

The trigger of setting a λ path and a label switched path is not specifically restricted, but, for example, methods explained in the first and second embodiment can be used.

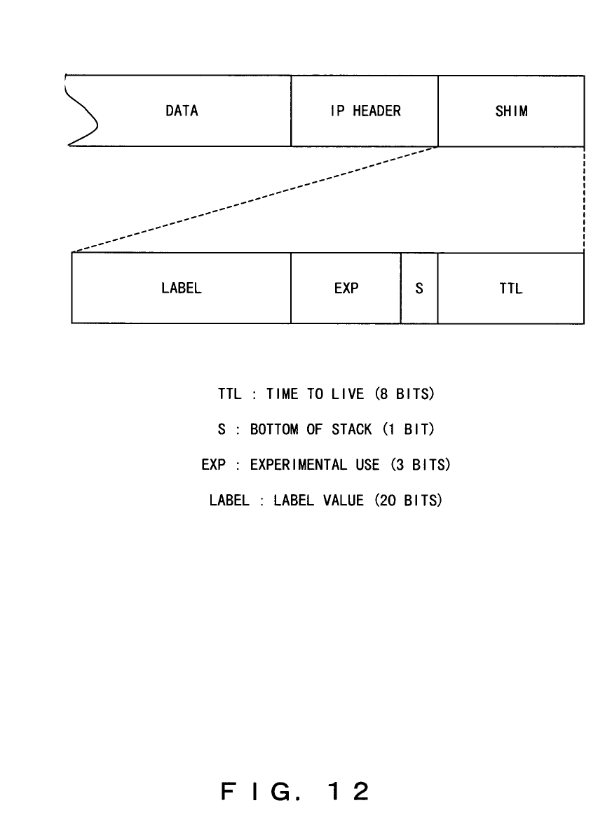

The tables provided for the edge devices 21 and 22 are basically the same as those according to the first embodiment. That is, the configuration of the tables provided for the edge device for processing a packet incoming from an IP network to a transport network is the same as the configuration of the tables according to the first embodiment shown in FIG. 8. Therefore, a packet transmitted over the transport network according to the third embodiment has the format having one Shim header as shown in FIG. 12. The configuration of the tables provided for the edge device which processes a packet outgoing from the transport network to the IP network is the same as the configuration of the tables according to the first embodiment shown in FIG. 9.

The configuration of the tables provided for the core devices 24a and 24c is the same as the configuration according to the first or second embodiment as shown in FIG. 10.

The configuration of the tables provided for the core device 26 is basically the same as the configuration according to the second embodiment shown in FIG. 18. However, according to the second embodiment, the label forwarding table 49 is set by the signaling protocol of the GMPLS. On the other hand, according to the third embodiment, the label forwarding table 49 is set by the signaling protocol of the MPLS.

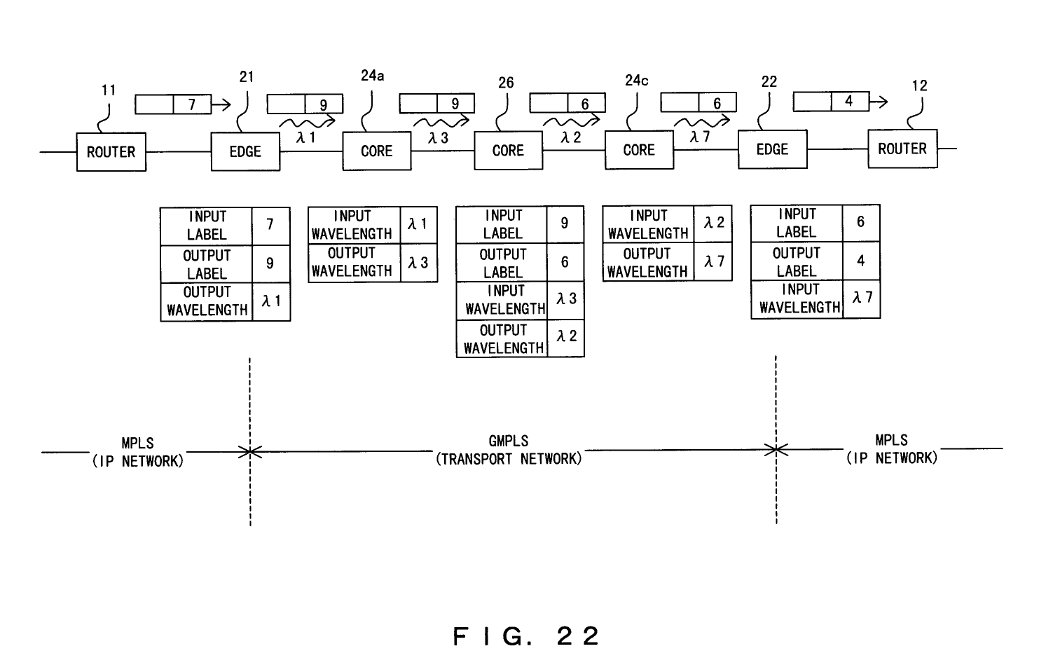

FIG. 22 shows an embodiment of the operation of transferring a packet using a path established in the method according to the third embodiment. In this embodiment, the tables 41 through 43 provided for the edge device 21, the tables 41, 42, 44, and 45 provided for the edge device 22, the tables 46 and 47 provided for the core devices 24a and 24c, and the tables 46, 47, and 49 provided for the core device 26 are assumed to have been already set by the signaling shown in FIG. 21.

In this network, upon receipt of a packet assigned a “label=71” from the router device 11, the edge device 21 refers to the table shown in FIG. 8, and rewrites the label value from “7” to “9”. The edge device 21 transmits the packet to the core device 24a using the wavelength λ1.

Upon receipt of the signal with the wavelength λ1 from the edge device 21, the core device 24a converts the wavelength of the signal from “λ1” to “λ3”, and transmits the signal to the core device 26 as in the first embodiment. At this time, the label is not rewritten.

The core device 26 regenerates a packet from a received signal, and rewrites the label of the packet from “9” to “6”. At this time, the core device 26 provides a service (QoS, etc.) of the packet layer according to the label forwarding table 49 shown in FIG. 18. Then the core device 26 transmits the packet to the core device 24c with the wavelength λ2.

Upon receipt of the signal with the wavelength λ2 from the core device 26, the core device 24c converts the wavelength of the signal from “λ2” to “λ7”, and transmits the signal to the edge device 22 as in the first embodiment. At this time, the label is not rewritten.

Thus, according to the embodiment, the core device 26 provided in the transport network terminates a label switched path by the MPLS, and can provide a service of the packet layer for a packet transferred through a tunnel using the λ path.

Upon receipt of the signal with the wavelength 7 from the core device 24c, the edge device 22 regenerates a packet from the received signal, rewrites the label of the packet from “6” to “4”, and transmits it to the router device 12.

Thus, according to the third embodiment, as in the second embodiment, a service of the packet layer can be provided in a desired node in the GMPLS network. Here, in the third embodiment, a service integrated in IP network can be provided. However, in the third embodiment as compared with the second embodiment, the configuration of a packet in the transport network is simpler, and the label rewriting process in the edge device can be more easily performed.

Each protocol in the sequence shown in FIGS. 7, 14, and 21 is an embodiment, and an arbitrary MPLS signaling protocol can be combined with an arbitrary GMPLS signaling protocol.

In the network of the third embodiment, one or more GMPLS paths can be set outside or parallel to the path 33a and path 33b. In this case, the GMPLS paths can be terminated by an arbitrary node through which the path 33a or path 33b passes. Furthermore, another GMPLS path (PSC LPS) cab be set inside or parallel to the path 36.

Practical Embodiment

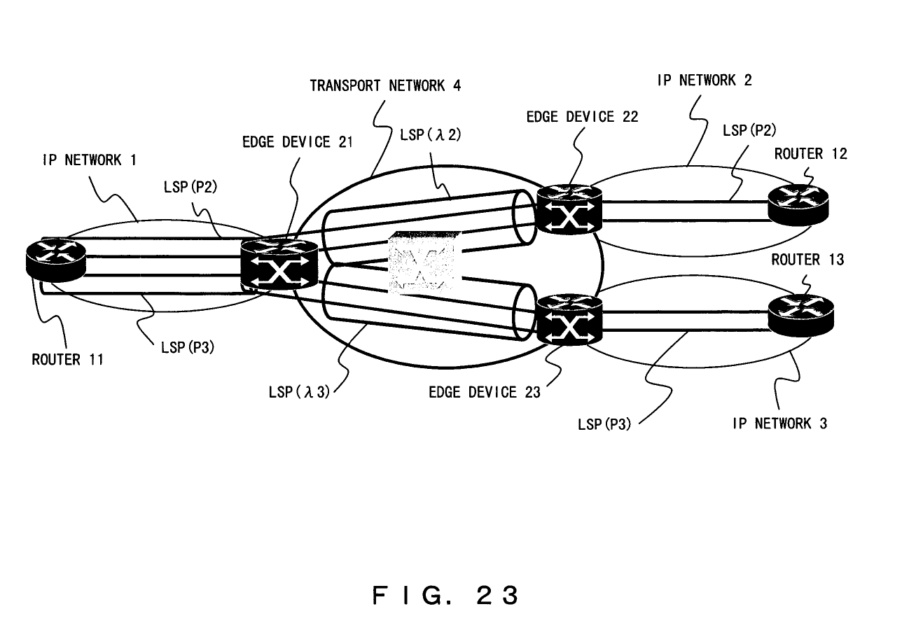

FIG. 23 shows a concrete embodiment of a method of connecting networks according to the present invention. Described below is an example of the first embodiment.

In FIG. 23, the LSP (λ2) is a wavelength label switched path established between the edge device 21 and the edge device 22, and the LSP (λ3) is a wavelength label switched path established between the edge device 21 and the edge device 23. The LSP (P2) is a label switched path by the MPLS established between the router device 11 and the router device 12, and the LSP (P3) is a label switched path by the MPLS established between the router device 11 and the router device 13. With the configuration, in the transport network 4, the LSP (λ2) functions as a tunnel for the LSP (P2), and the LSP (λ3) functions as a tunnel for the LSP (P3).

To configure this network, the following procedure is performed to initialize the settings.

1. Each device (in this example, the edge devices 21, 22, 23, and the core device) sets an IP address for a data channel and a control channel. It is also possible to use an unnumbered link without setting an IP address, but an interface identifier is set in this case.

2. By the OSPF (open shortest path first), topology information of the control plane is communicated among the devices (in this case, the edge devices 21, 22, and 23, and a core device). Thus, a control message can be communicated among the devices.

3. By the OSPF, the topology information of a data plane (a wavelength layer in this case) is communicated. Thus, the edge devices 21 through 23 and the core device recognize the topology relating to the control plane and the data plane.

Then, the λ path (wavelength LSP) is set as follows. That is, a wavelength LSP of full-mesh among edge devices is set using the trigger of recognizing the topology about the data plane in the above-mentioned initial procedure. In FIG. 23, no path is drawn between the edge device 22 and the edge device 23. In another method, only the wavelength path between the edge device 21 and the edge device 22, and the wavelength path between the edge device 21 and the edge device 23 can be set at a direction of a network management device.

Furthermore, in the following procedure, a pure MPLS label switched path is set.

1. An IP address is set between edge devices using the wavelength LSP set in the above-mentioned procedure as a data link. It is also possible to use an unnumbered link without setting an IP address. However, in this case, an interface identifier is set.

2. Using the wavelength LSP set in the above-mentioned procedure as a data link, the topology information about the data plane (a packet layer in this case) is communicated by the OSPF between the edge devices.

3. The topology information about the IP is communicated by the OSPF between the edge devices and the router devices.

4. The router device 11 recognizes the path to the router devices 12 and 13 according to the topology information about the IP obtained in 3 above, and a label switched path toward the router devices 12 and 13 by the pure MPLS is set.

5. Since the edge device 21 is informed that the router device 12 precedes the LSP (λ2), and the router device 13 precedes the LSP (λ3), the LSP (P2) is set in the LSP (λ2), and the LSP (P3) is set in the LSP (λ3).

Configuration of the Device

In the first through third embodiments, the router devices 11 and 12, the edge devices 21 and 22, the core devices 24 (24a to 24c), 25, and 26 are included. Among theses devices, the router devices 11 and 12 can be realized by the conventional technology. The core devices 24 and 25 can also be realized by the conventional technology. However, the edge devices 21 and 22, and the core device 26 are the devices which support both MPLS and GMPLS, and can be realized by the present invention.

In the MPLS, the data plane and the control plane are not separate from each other. However, they are separate from each other in the GMPLS. Therefore, to support both MPLS and GMPLS, the function of terminating the control data communicated through the data plane, and the function of terminating the control data communicated through the control plane are required.

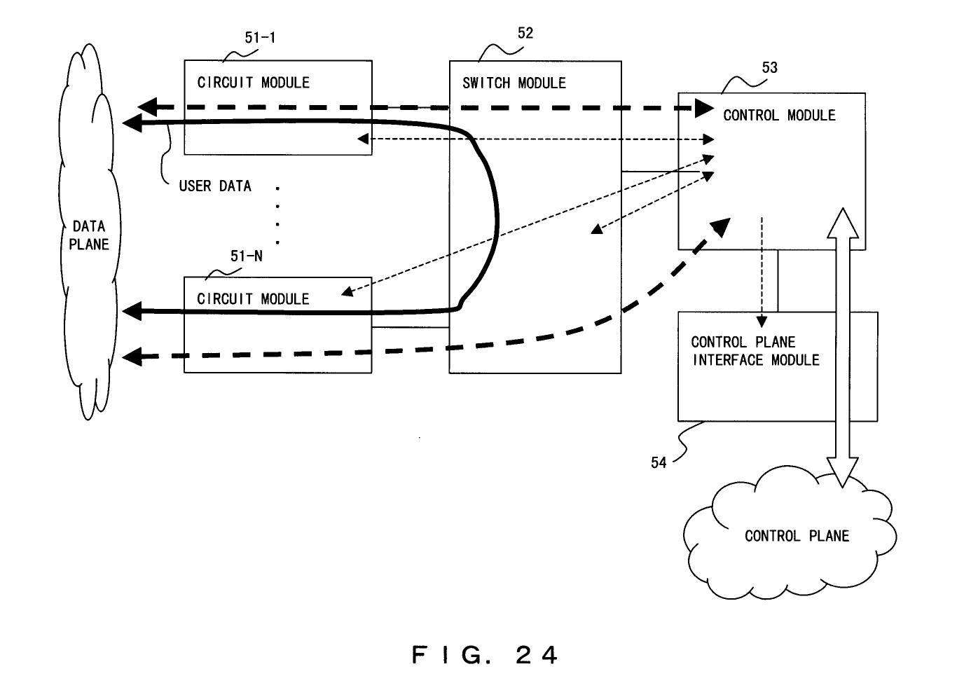

FIG. 24 shows the configuration of the device which supports both MPLS and GMPLS. The device corresponds to, for example, the edge devices 21 and 22, or the core device 26 according to the third embodiment.

Circuit modules 51-1 through 51-N accommodate respective physical circuit interfaces. The circuit modules 51-1 through 51-N are connected to the data plane of the GMPLS network. However, in the edge device, the circuit modules 51-1 through 51-N are also connected to the MPLS network. The circuit modules 51-1 through 51-N guide the data received from the corresponding circuit to a switch module 52, and the data received from the switch module 52 is output to the corresponding circuit. The data incoming from a corresponding circuit includes user data and the signaling message of the MPLS. Therefore, the circuit modules 51-1 through 51-N have the function of determining whether the received data is user data or a signaling message of the MPLS.

The switch module 52 switches between the circuit modules 51-1 through 51-N and between the circuit modules 51-1 through 51-N and the control module 53.

The control module 53 manages/controls the circuit modules 51-1 through 51-N, the switch module 52, and a control plane interface module 54. It also terminates the GMPLS signaling, and communicates a signaling message of the GMPLS through the control plane interface module 54. Furthermore, it terminates the MPLS signaling, and communicates a signaling message of the MPLS through the circuit modules 51-1 through 51-N. Thus, a signaling message of the MPLS can be communicated through a data channel of the GMPLS.

The control plane interface module 54 terminates a control plane interface of the GMPLS, and communicates a signaling message of the GMPLS.

With this configuration, when user data (packet) is input from a circuit module corresponding to a source device, it is guided to a circuit module corresponding to a destination device without being transferred to the control module 53. A signaling message of the MPLS signaling transmitted from the data plane of the GMPLS network or the MPLS network is guided to the control module 53 through the switch module 52. On the other hand, a signaling message of the MPLS generated by the control module 53 is transmitted to the data plane of the GMPLS network or the MPLS network through the circuit module corresponding to a destination device. Furthermore, a signaling message of the GMPLS transmitted from the control plane of the GMPLS network is guided to the control module 53 through the control plane interface module 54, and a signaling message of the GMPLS generated by the control module 53 is transmitted to the control plane of the GMPLS network through the control plane interface module 54.

Thus, in the circuit modules 51-1 through 51-N, control data (the signaling message of the MPLS in this case) and user data are identified, and the transfer destination in the device of the data is determined based on the identification result. Then, these functions enable the signaling message of the MPLS to be communicated on the data channel of the GMPLS.

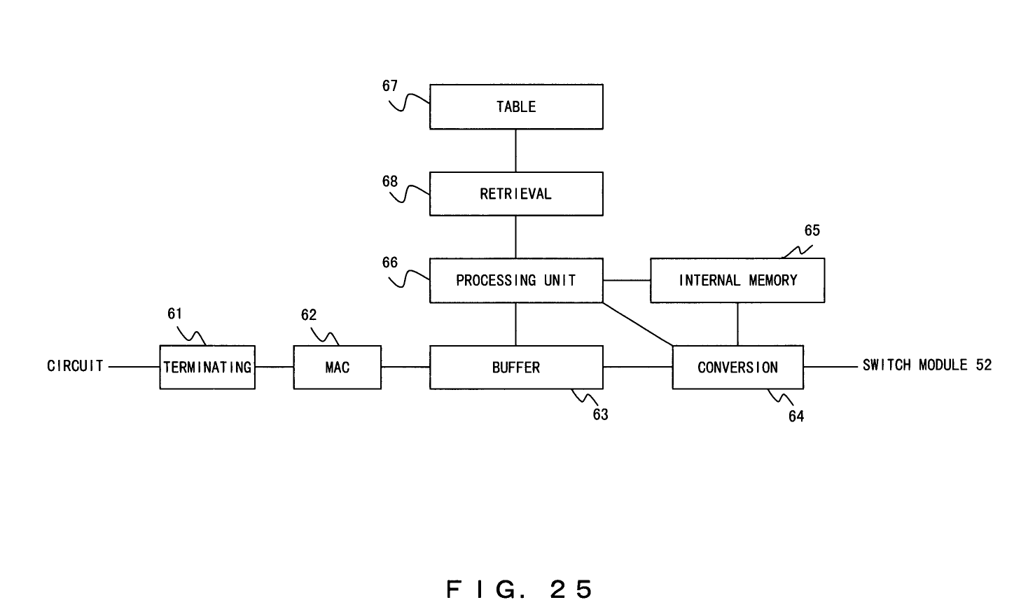

FIG. 25 shows the configuration of a circuit module. A terminating unit 61 terminates a circuit. A “circuit” includes a circuit configuring a data plane of the GMPLS network and a circuit configuring the data/control plane of the MPLS network. A MAC processing unit 62 performs a process in a MAC layer about a signal communicated through a circuit terminated by the terminating unit 61. A buffer 63 temporarily stores data (a packet) communicated through a circuit terminated by the terminating unit 61. A conversion unit 64 converts the format of the packet communicated through a circuit terminated by the terminating unit 61 and the internal format of the device. An internal memory 65 includes data/command memory, request/status memory, and statistical information collection memory.

A processing unit 66 analyzes a packet communicated through a circuit terminated by the terminating unit 61, and performs a necessary process. The process performed by the processing unit 66 includes the process of determining whether a received packet stores control data (a signaling message of the MPLS, etc.) or user data. The determination is made based on, for example, the IP address of a received packet. That is, when a packet stores control data, an IP address predetermined as the destination address of the packet is used, and the processing unit 66 can make the above-mentioned determination based on the IP address. The process performed by the processing unit 66 includes the process of rewriting a label in a Shim header assigned to a packet.

A table 67 is explained in the first through third embodiments, and manages a label to be assigned to a packet, a wavelength for transmitting a signal, etc. Practically, in the circuit modules of the edge devices 21 and 22, for example, the tables shown in FIGS. 8, 9, 15, etc. are provided. In the circuit module of the core device 26, for example, the tables shown in FIG. 18 are provided. The contents of the table 67 is basically updated at a direction from the control module 53. A retrieval unit 68 obtains corresponding information from the table 67 at a direction from the processing unit 66.

In this circuit module, when a packet is received through a circuit terminated by the terminating unit 61, it is checked whether of not control data is stored in the packet. When control data is stored, the packet is transmitted to the control module 53 through the switch module 52. If control data is not stored, the label of the packet is rewritten as necessary, and then transmitted to a circuit module corresponding to the destination address. When a packet is received from the switch module 52, the packet is output to a corresponding circuit.

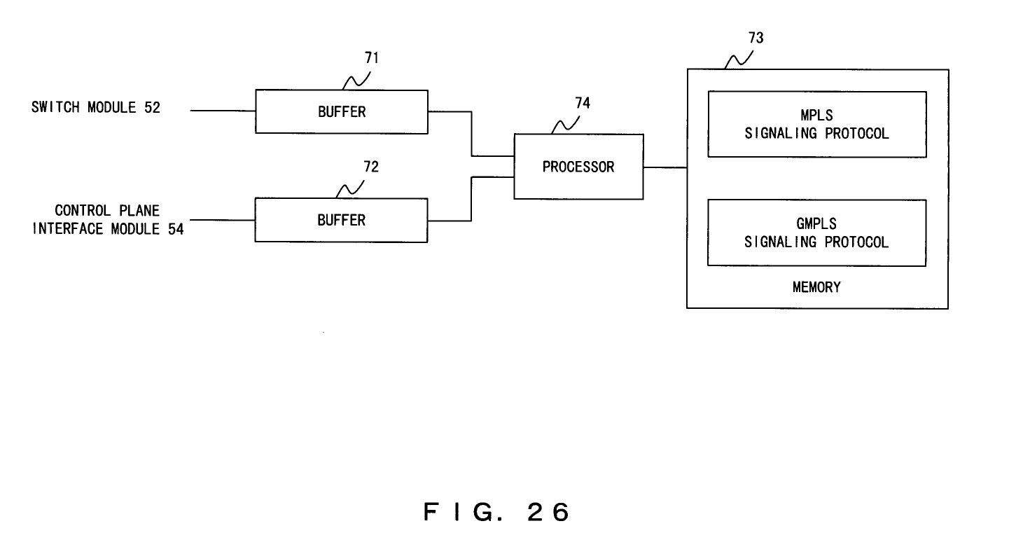

FIG. 26 shows the configuration of a control module 53. A buffer 71 temporarily stores data communicated with the circuit modules 51-1 through 51-N. A buffer 72 temporarily stores data communicated with the control plane interface module 54. Memory 73 stores at least a program describing the process corresponding to the MPLS signaling protocol, and a program describing the process corresponding to the GMPLS signaling protocol. A processor 74 sets a path by the MPLS and/or a path by the GMPLS by executing the program stored in the memory 73. “Setting a path” includes a process of updating the table 67 according to a message communicated in the sequence shown in FIGS. 7, 14, and 21.

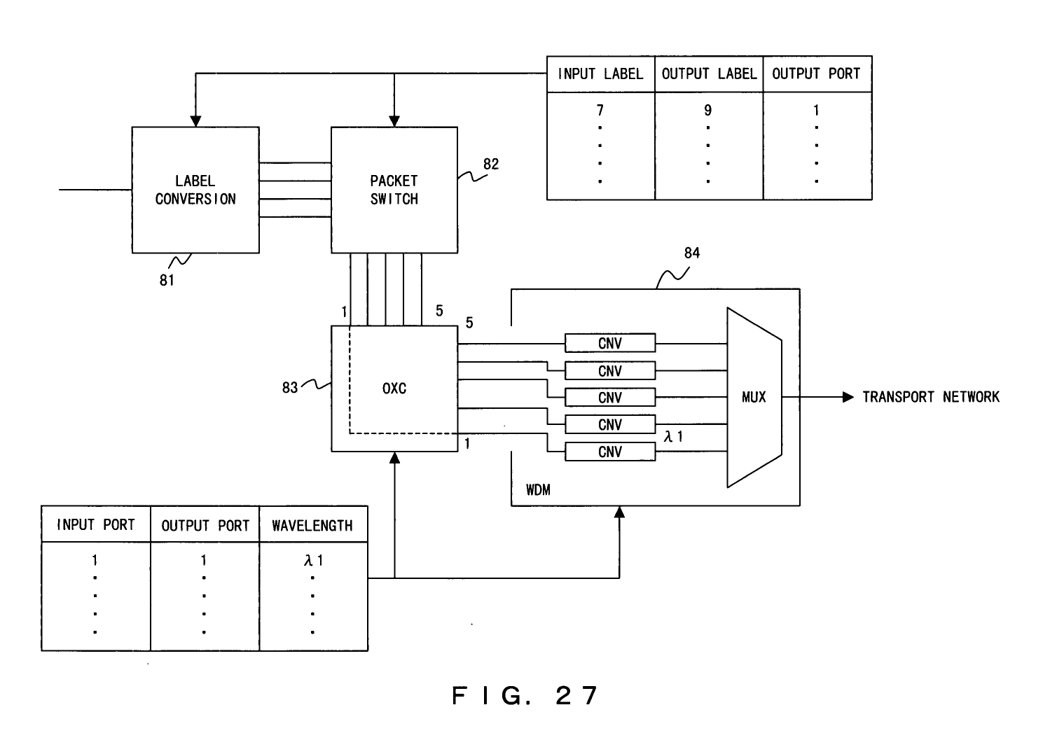

FIG. 27 shows a schematic diagram of the configuration and the operation of an edge device. A label conversion unit 81 rewrites a label of a received packet. A packet switch 82 guides a packet whose label has been rewritten to an optical cross connect (OXC) 83. The optical cross connect 83 guides the input optical signal to a WDM device 84. Then, the WDM device 84 multiplexes input light and outputs the multiplexed light to a transport network.

In the edge device with this configuration, when a λ path by the GMPLS is set, the optical cross connect 83 is set such that the output of the packet switch 82 can be guided to an available port of the WDM device 84. Additionally, the WDM device 84 is set such that a signal can be transmitted at the label (label=wavelength in this case) determined by the signaling of the GMPLS. In FIG. 27, a signal input through an input port 1 of the optical cross connect 83 is set to be guided to an output port 1, and then transmitted by “wavelength =λ1”.

When a label switched path by the MPLS is set, a set of input label/output label determined by the signaling of the MPLS is set in a next hop label forwarding table. At this time, the label switched path by the MPLS is set such that it tunnels the λ path by the GMPLS. Practically, the packet switch 82 is set such that a port for an already reserved λ path can be assigned as an output port corresponding to an output label. In FIG. 27, a label assigned to a packet is rewritten from “7” to “9”, and then guided to the input port 1 of the WDM device 84.

In this settings, an output label is determined by referring to a next hop label forwarding table using an input label as a key. Then, the output port of the packet switch 82 is determined based on the output label, based on which the input port of the WDM device 84 is determined. Then, a wavelength conversion is performed based on the input port of the WDM device 84. As a result, forwarding is performed with a label for identifying a label switched path of the MPLS and a wavelength label of the GMPLS assigned.

According to the present invention, IP networks not supporting the signaling protocol of the GMPLS can be connected to each other through a transport network. At this time, a MPLS network and a GMPLS network can be integrally managed.

Furthermore, in a transport network, a communications service of a packet layer can be provided in cooperation with a device configuring an IP network.

What is claimed is:

1. A network connecting method for interconnecting a first MPLS network to a second MPLS network which support a signaling protocol of MPLS through a GMPLS network which supports a signaling protocol of GMPLS, comprising:
setting a first path using a signaling protocol of the GMPLS between a first edge node provided at a boundary between the GMPLS network and the first MPLS network and a second edge node provided at the boundary between the GMPLS network and the second MPLS network; and
setting a second path which tunnels the first path using the signaling protocol of the MPLS between the first MPLS network and the second MPLS network.

2. A network connecting method for interconnecting a first IP network to a second IP network which support a second signaling protocol through a transport network which supports a first signaling protocol, comprising:
setting a first path using a first signaling protocol between a first edge node provided at a boundary between the transport network and the first IP network and a second edge node provided at a boundary between the transport network and the second IP network; and
setting a second path which tunnels the first path using the second signaling protocol between the first and second IP networks.

3. A network connecting method for interconnecting a first MPLS network to a second MPLS network which support a signaling protocol of MPLS through a GMPLS network which supports a signaling protocol of GMPLS, comprising:
setting a first path using the signaling protocol of the GMPLS between a first edge node provided at a boundary between the GMPLS network and the first MPLS network and a core device provided in the GMPLS network;
setting a second path using the signaling protocol of the GMPLS between a second edge node provided at a boundary between the GMPLS network and the second MPLS network and the core device;
setting a third path which tunnels the first path and the second path between the first edge node and the second edge node using the signaling protocol of the GMPLS; and
setting a fourth path which tunnels the third path between the first MPLS network and the second MPLS network using the signaling protocol of the MPLS.

4. A network connecting method for interconnecting a first IP network to a second IP network which support a second signaling protocol through a transport network which supports a first signaling protocol, comprising:
setting a first path using the first signaling protocol between a first edge node provided at a boundary between the transport network and the first IP network and a core device provided in the transport network;
setting a second path using the first signaling protocol between a second edge node provided at a boundary between the transport network and the second IP network and the core device;
setting a third path which tunnels the first path and the second path between the first edge node and the second edge node using the first signaling protocol; and
setting a fourth path which tunnels the third path between the first IP network and the second IP network using the second signaling protocol.

5. The method according to claim 3, wherein
said third path is a label switched path of a packet layer.

6. A network connecting method for interconnecting a first MPLS network to a second MPLS network which support a signaling protocol of MPLS through a GMPLS network which supports a signaling protocol of GMPLS, comprising:
setting a first path using the signaling protocol of the GMPLS between a first edge node provided at a boundary between the GMPLS network and the first MPLS network and a core device provided in the GMPLS network;
setting a second path using the signaling protocol of the GMPLS between a second edge node provided at a boundary between the GMPLS network and the second MPLS network and the core device; and
setting a third path which tunnels the first path and the second path between the first MPLS network and the second MPLS network using the signaling protocol of the MPLS.

7. A network connecting method for interconnecting a first IP network to a second IP network which support a second signaling protocol through a transport network which supports a first signaling protocol, comprising:
setting a first path using the first signaling protocol between a first edge node provided at a boundary between the transport network and the first IP network and a core device provided in the transport network;
setting a second path using the first signaling protocol between a second edge node provided at a boundary between the transport network and the second IP network and the core device; and
setting a third path which tunnels the first path and the second path between the first IP network and the second IP network using the second signaling protocol.

8. The method according to claim 6, wherein said third path is a label switched path of the MPLS.

9. An edge device provided at a boundary between a GMPLS network supporting a signaling protocol of GMPLS and a MPLS network supporting a signaling protocol of MPLS, comprising:
a first storage unit storing information identifying a first path set by the signaling protocol of the GMPLS;
a second storage unit storing information identifying a second path set by the signaling protocol of the MPLS; and
a link unit associating the information stored in said first storage unit with the information stored in said second storage unit so that the second path tunnels the first path.

10. A core device provided in a GMPLS network supporting a signaling protocol of GMPLS connected to a MPLS network supporting a signaling protocol of MPLS, comprising:
a control unit performing a signaling process of the MPLS;
a circuit terminating unit terminating a signal of a data plane of the GMPLS, and detecting a signaling message of the MPLS from the terminated signal; and
a switch unit guiding the detected signaling message to said control unit, and guiding a signaling message obtained by performing the signaling process of the MPLS by said control unit.

11. The method according to claim 1, wherein
setting a GMPLS path outside or parallel to the first path, wherein the GMPLS path is terminated by an arbitrary node through which the second path passes.

12. The method according to claim 1, wherein
setting MPLS path inside or parallel to the second path.

13. The method according to claim 3, wherein
setting a GMPLS path outside or parallel to the first and second paths, wherein the GMPLS path is terminated by an arbitrary node through which the first and second paths pass.

14. The method according to claim 3, wherein
setting a GMPLS path outside or parallel to the third path, wherein the GMPLS path is terminated by an arbitrary node through which the third path passes.

15. The method according to claim 3, wherein
setting a GMPLS path inside or parallel to the fourth path.

16. The method according to claim 6, wherein
setting a GMPLS path outside or parallel to the first and second paths, wherein the GMPLS path is terminated by an arbitrary node through which the first or second path passes.

17. The method according to claim 6, wherein
setting a GMPLS path inside or parallel to the third path.
